(19) United States
(12) Patent Application Publication
(10) Pub. No.: US 2026/0242890 A1
(43) Pub. Date: Aug. 20, 2026

(54) EXTRACTION OF METALS FROM AN AQUEOUS SOLUTION

(71) Applicant: Iowa State University Research Foundation, Inc., Ames, IA (US)

(72) Inventors: Long Qi, Ames, IA (US); Lun An, Ames, IA (US); Zhenqi Zhao, Ames, IA (US)

(21) Appl. No.: 19/540,051

(22) Filed: Feb. 13, 2026

Related U.S. Application Data
(60) Provisional application No. 63/758,613, filed on Feb. 14, 2025.

(51) Int. Cl. C22B 3/24; C08G 69/40; C22B 11/00; C22B 59/00

(52) U.S. Cl. CPC C22B 3/24; C08G 69/40; C22B 11/04; C22B 59/00

(57) ABSTRACT

A method of extracting one or more metals from an aqueous solution includes forming a heterogeneous solution including a polyamide and the aqueous solution including the one or more metals therein, such that the polyamide sorbs at least some of the one or more metals in the aqueous solution. The method includes removing the polyamide from the heterogeneous solution to form a post-extracted solution having a lower concentration of the one or more metals than the aqueous solution. The polyamide is an amidization product of one or more polyamines and a polyacid, polyacid ester, or polyacyl halide.

### CROSS-REFERENCE TO RELATED APPLICATION

This application claims the benefit of priority to U.S. Provisional Patent Application Ser. No. 63/758,613 filed Feb. 14, 2025, the disclosure of which is incorporated herein in its entirety by reference.

### STATEMENT OF GOVERNMENT SUPPORT

This invention was made with government support under DE-AC02-07CH11358 awarded by the Department of Energy. The government has certain rights in the invention.

### BACKGROUND

Minerals are critical to the production of advanced materials for the transformation towards carbon neutrality. Examples of these minerals include but are not limited to: (1) rare-earth elements (REEs), including a family of 17 elements, exhibit unique physical and chemical properties and thus find wide applications in modern society such as permanent magnets; and (2) lithium (Li) and (3) cobalt/nickel/manganese (Co/Ni/Mn) are of surging demands to meet the needs of battery materials for electric vehicles and stationery energy storage.

Over the past decades, several techniques have been developed to achieve efficient separation, of which the hydrometallurgical method via liquid-liquid extraction (LLE) is an extensively studied process for large-scale industrial applications. In this process, these minerals are converted to corresponding metal salts in an aqueous solution, subsequently treated with an immiscible organic solvent containing one or a combination of lipophilic extractants (ligands), typically small molecules, which bind the critical minerals and transfer them into the lipophilic organic phase, thus realizing separation.

However, the utilization of LLE frequently encounters practical hurdles for new separation processes, among which the excessive consumption of organic-phase solvents in the two-phase extraction process not only gives rise to significant environmental concerns but also escalates operational costs. Prior comprehensive life cycle assessments of REE production have underscored the significant environmental footprint attributable to solvent extraction. Additional issues associated with LLE encompass sluggish extraction kinetics, limited solubility of certain extractants in aliphatic diluents, emulsion formation, and gradual loss of valuable ligands.

### SUMMARY OF THE INVENTION

Various aspects of the present disclosure provide a method of extracting one or more metals from an aqueous solution. The method includes forming a heterogeneous solution including a polyamide and the aqueous solution, wherein the aqueous solution includes the one or more metals therein, such that the polyamide sorbs at least some of the one or more metals in the aqueous solution. The method also includes removing the polyamide from the heterogeneous solution to form a post-extracted solution having a lower concentration of the one or more metals than the aqueous solution. The polyamide is an amidization product of one or more polyamines and a polyacid, polyacid ester, or polyacyl halide.

Various aspects of the present disclosure provide a method of forming the polyamide used in various aspects of the method of extracting one or more metals from an aqueous solution of the present disclosure. The method of forming the polyamide includes combining one or more polyamines and a polyacid, polyacid ester, or polyacyl halide to form a reaction mixture including a polymeric ammonium salt. The method also includes heating the polymeric ammonium salt to form the polyamide.

Various aspects of the present disclosure provide a method of extracting one or more metals from an aqueous solution. The method includes forming a heterogeneous solution including a solid polyamide and the aqueous solution, wherein the aqueous solution includes the one or more metals therein, such that the polyamide sorbs at least some of the one or more metals in the aqueous solution, wherein the one or more metals include La, Ce, Pr, Nd, Sm, Eu, Gd, Tb, Dy, Ho, Er, Tm, Yb, Lu, Ca, Co, Mg, Mn, Ni, or a combination thereof. The solid polyamide is substantially insoluble in the aqueous solution. The method also includes removing the polyamide from the heterogeneous solution to form a post-extracted solution having a lower concentration of the one or more metals than the aqueous solution. The polyamide is an amidization product of one or more polyamines and diglycolic acid.

Various aspects of the method of extracting one or more metals from an aqueous solution provide advantages over other methods for extracting metals. For example, various aspects of the method of the present disclosure can provide environmental benefits over other methods for extracting metals, such as significant reduction of organic solvent consumption compared to traditional liquid-liquid extraction, which in turn lowers both environmental impact and operational costs. Various aspects of the method of the present disclosure can substantially decrease the generation of inorganic/organic wastes and provide a reduced environmental footprint, as compared to traditional solvent extraction processes.

Various aspects of the method of the present disclosure can provide process efficiency benefits over other methods for extracting metals. For example, various aspects of the present disclosure can achieve faster phase equilibrium, provide a higher separation factor, and enable faster phase separation, as compared to conventional methods such as traditional liquid-liquid extraction.

Various aspects of the method of the present disclosure can provide structural and cost-benefit advantages over other methods for extracting metals. For example, various aspects of the polyamide used in various aspects the present disclosure can contain sufficient coordination sites in nearly all polymer repeating units, can allow molecular-level tuning of coordination sites through alkyl chain modifications, can bridge the interface between molecular extractive ligands and conventional extraction material, can enable drawing from best attributes of both small-molecule extractants and polymeric materials, or a combination thereof. Various aspects of the method of the present disclosure can reduce operational costs by minimizing organic solvent usage and can eliminate the need for expensive organic phase solvents in two-phase extraction processes.

Various aspects of the method of the present disclosure can provide advantages of greater versatility and more practical implementation as compared to other methods for extracting metals. For example, various aspects of the method of the present disclosure have been demonstrated to be applicable for extraction of various metals including rare-earth elements (REEs), calcium (e.g., with 60% extraction efficiency), and other metals like cobalt, manganese, and nickel under specific conditions. In various aspects of the method of the present disclosure, the polyamide can be formulated into various forms (e.g., beads, membranes, and the like). In various aspects of the present disclosure, the method provides a solution to common liquid-liquid extraction problems such as sluggish extraction kinetics, limited solubility of certain extractants in aliphatic diluents, emulsion formation, and gradual loss of valuable ligands, and can enhance both the efficiency and sustainability of the extraction process.

### BRIEF DESCRIPTION OF THE FIGURES

The drawings illustrate generally, by way of example, but not by way of limitation, various aspects of the present invention.

FIG. 1A illustrates synthesis of various polymeric diglycolamides, in accordance with various aspects of the present disclosure.

FIG. 1B illustrates synthesis of various polymeric diglycolamides, in accordance with various aspects of the present disclosure.

FIG. 1C illustrates synthesis of various polymeric diglycolamides, in accordance with various aspects of the present disclosure.

FIG. 2A illustrates various polymeric diglycolamides with various linkers and functionalities, in accordance with various aspects of the present disclosure.

FIG. 2B illustrates various polymeric diglycolamides with various linkers and functionalities, in accordance with various aspects of the present disclosure.

FIG. 3 illustrates sorption of lanthanides with a polymeric diglycolamide, in accordance with various aspects of the present disclosure.

FIG. 4 illustrates extraction efficiency for various lanthanides using two different polymeric diglycolamides, in accordance with various aspects of the present disclosure.

FIG. 5 illustrates extraction efficiency for a DGA polymer for various tested metals in HCl or H₂SO₄, in accordance with various aspects of the present disclosure.

FIG. 6 illustrates extraction efficiency for various DGA polymers for various tested metals using 1.5 M H₂SO₄ or pH 5 H₂SO₄ solution, in accordance with various aspects of the present disclosure.

FIG. 7 illustrates extraction efficiency for various lanthanides using two different polymeric diglycolamides, in accordance with various aspects of the present disclosure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range but also all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid the reading of the document and is not to be interpreted as limiting; information relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some aspects, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups. The term “hydrocarbyl” can refer to a functional group derived from a straight chain, branched, or cyclic hydrocarbon, and can be alkyl, alkenyl, alkynyl, aryl, cycloalkyl, acyl, or any combination thereof.

Method of Extracting One or More Metals from an Aqueous Solution.

Various aspects of the present invention provide a method of extracting one or more metals from an aqueous solution. The method can include forming a heterogeneous solution including a polyamide and the aqueous solution, wherein the aqueous solution includes the one or more metals therein, such that the polyamide sorbs at least some of the one or more metals in the aqueous solution. The method can include removing the polyamide from the heterogeneous solution to form a post-extracted solution having a lower concentration of the one or more metals than the aqueous solution. The polyamide can be an amidization product of one or more polyamines and a polyacid, polyacid ester, or polyacyl halide.

The one or more metals in the aqueous solution are one or more dissolved metals. The metals in the aqueous solution can be in the form of metal salts. The heterogeneous solution is heterogeneous at least because the polyamide does not dissolve in and is not miscible with the aqueous solution. The polyamide can be in the form of a solid or an oil in the aqueous solution. The polyamide can be a solid polyamide that is substantially free of dissolution in the aqueous solution. The polyamide can be in the form of particles, beads, a membrane, or other three-dimensional shapes. The polyamide can be bonded to a solid support such as an organic or inorganic support. The polyamide can be free of a solid support.

As compared to liquid-liquid extraction, solid-liquid extraction (SLE) is a more environmentally friendly and cost-effective method for metals such as REEs. As compared to the LLE, various aspects of the method of the present disclosure have a higher separation factor, faster phase equilibrium, and a substantial reduction in consumption of organic solvents and generation of inorganic/organic wastes compared to traditional LLE. As compared to non-polymeric sorbents, the polyamide of various aspects of the method of the present disclosure can be formed into physical forms such as beads, membranes, and the like. As compared to non-polymeric sorbents, the polyamide of the present disclosure can have a higher density of coordination sites for the one or more metals. As compared to non-polymeric sorbents, the polyamide of the present disclosure can, in various aspects, be bonded to inorganic or organic supports more strongly, avoiding or decreasing degradation upon repetitive usage.

The polyamide can be an amidization product of one or more polyamines and a polyacid, polyacid ester, or polyacyl halide. The polyacid ester can be any suitable polyacid or ester derived therefrom. The polyacid or ester can be a diacid or a diester. The polyacid or ester can be diglycolic acid, oxalic acid, malonic acid, succinic acid, glutaric acid, adipic acid, pimelic acid, a substituted or unsubstituted (C₁-C₃₀)hydrocarbyl ester derived therefrom, or a combination thereof. The polyacid or ester can be a triacid or a triester. The polyacid or ester can be citric acid, a substituted or unsubstituted (C₁-C₃₀)hydrocarbyl ester derived therefrom, or a combination thereof. The polyacid or ester can be polyacrylic acid, polymethacrylic acid, a substituted or unsubstituted (C₁-C₃₀)hydrocarbyl ester derived therefrom, or a combination thereof. The polyacid or ester can be a diglycolic acid or an ester having the structure R³O—C(O)—CH(R¹)—O—CH(R²)—C(O)—OR⁴, wherein R³ and R⁴ can be independently chosen from —H and a substituted or unsubstituted (C₁-C₃₀)hydrocarbyl optionally interrupted by 0, 1, 2, or 3 groups independently chosen from —O— and —S—, and R¹ and R² can be independently chosen from —H and a substituted or unsubstituted (C₁-C₃₀)hydrocarbyl optionally interrupted by 0, 1, 2, or 3 groups independently chosen from —O— and —S—. The variables R¹, R², R³, and R⁴ can be —H. The polyacid or ester can be diglycolic acid or a substituted or unsubstituted (C₁-C₃₀)hydrocarbyl ester derived therefrom, and the polyamide can be a polymeric diglycolamide.

The polyacyl halide can be any suitable polyacyl halide. The polyacyl halide can be a diacyl halide or a triacyl halide. The polyacyl halide can be a diglycolyl halide, malonyl halide, succinyl halide, glutaryl halide, adipyl halide, pimelyl halide, citryl halide, polyacrylyl halide, polymethacrylyl halide, or a combination thereof. The halide can be chloride, bromide, fluoride, or iodide. The polyacyl halide can be a dicarbonyl chloride (a diacyl chloride). The polyacyl halide can be a diglycolyl halide having the structure X—C(O)—CH(R¹)—O—CH(R²)—C(O)—X, wherein X is halide, and R¹ and R² can be independently chosen from —H and a substituted or unsubstituted (C₁-C₃₀)hydrocarbyl optionally interrupted by 0, 1, 2, or 3 groups independently chosen from —O— and —S—. The variables R¹ and R² can be —H. The polyacyl halide can be a diglycolyl halide such as diglycolyl chloride and the polyamide can be a polymeric diglycolamide.

The polyamide can be an amidization product of one polyamine and the polyacid, polyacid ester, or polyacyl halide, or of more than one polyamine and the polyacid, polyacid ester, or polyacyl halide (e.g., two polyamines, three polyamines, or more). The polyamine can be one or more polyamines. The polyamine can be any suitable polyamine that can form an amidization product with the polyacid, polyacid ester, or polyacyl halide. The polyamine can be a diamine having two and not more than two amine groups. The polyamine can have greater than two amine groups. The amine groups can be independently chosen from —NH₂ groups and —N(CH₃)H groups. The polyamine can have the structure R¹—(CH₂)ₙ—X—(CH₂)_{y}—R¹ wherein R¹ is independently —NH₂ or —N(CH₃)H, n and y are independently 1 to 30, and X is —NH—, —N(CH₃)H, —O—, —N⁺(CH₃)(PF₆)⁻—, —O—S(═O)—O—, or —O—P(═O)(—OH)—O—. The polyamine can have the structure R¹—((CH₂)ₙ—X)_{y}—(CH₂)ₙ—R¹, wherein R¹ is independently —NH₂ or —N(CH₃)H, n and y are independently 1 to 30 (e.g., 1, 2, 3, 4, 5, 6, 7, 8, 9, 10, or more), and X is —NH—, —N(CH₃)H, or —O—. The polyamine can have the structure X(—R²—R¹)₃, wherein X is N or phenyl (e.g., 1, 3, 5-substituted phenyl), R² is —(CH₂)ₙ—, -phenyl-, —(CH₂)_{y}-phenyl-(CH₂)_{y}—, or absent, and R¹ is independently —NH₂ or —N(CH₃)H, wherein n is independently 1 to 30 (e.g., 1, 2, 3, 4, 5, 6, 7, 8, 9, 10, or more), and y is independently 0 to 30 (e.g., 0, 1, 2, 3, 4, 5, 6, 7, 8, 9, 10, or more). The polyamine can be hexamethylenediamine, 1,12-dodecanediamine, N¹-(3-aminopropyl)butane-1,4-diamine (spermidine), N¹,N⁶-dimethylhexane-1,6-diamine, O,O′-bis(3-aminopropyl)polyethylene glycol (e.g., having an Mn of 100 to 10,000, or 1,500 to 2,000, or less than or equal to 10,000 and greater than or equal to 100 and less than, equal to, or greater than 200, 400, 600, 800, 1,000, 1,200, 1,400, 1,500, 1,600, 1,700, 1,800, 1,900, 2,000, 2,200, 2,400, 2,800, 3,000, 4,000, 5,000, 6,000, 7,000, 8,000, or 9,000), polyethyleneamine (e.g., having an Mn of 100 to 10,000, or 1,500 to 2,000, or less than or equal to 10,000 and greater than or equal to 100 and less than, equal to, or greater than 200, 400, 600, 800, 1,000, 1,200, 1,400, 1,500, 1,600, 1,700, 1,800, 1,900, 2,000, 2,200, 2,400, 2,800, 3,000, 4,000, 5,000, 6,000, 7,000, 8,000, or 9,000),

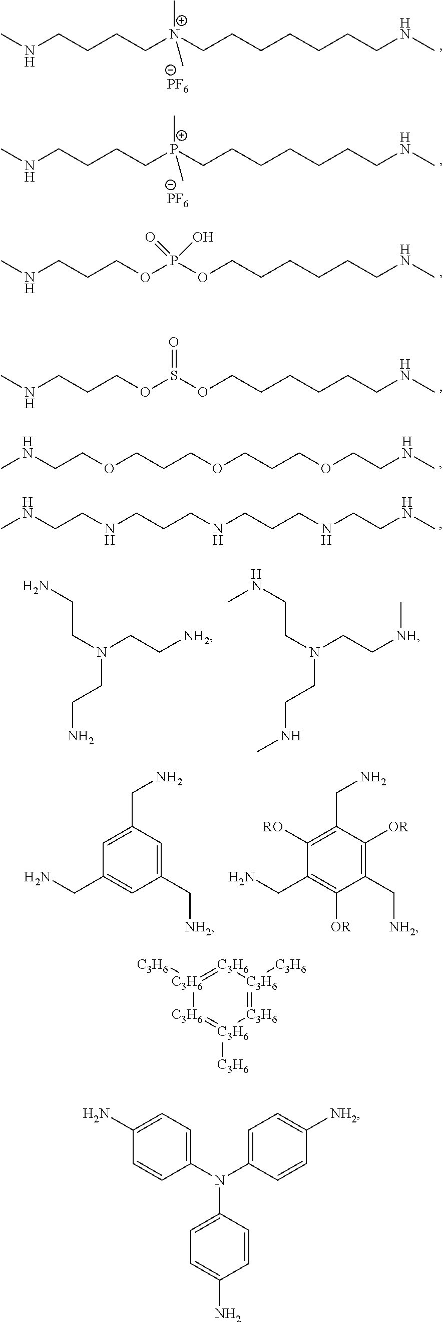

or a combination thereof, wherein R is a substituted or unsubstituted (C₁-C₃₀)hydrocarbyl optionally interrupted by 0, 1, 2, or 3 groups independently chosen from —O— and —S—, n is 2 to 1,000,000, and x is 1 to 1,000,000. The one or more polyamines can be hexamethylenediamine, 1,12-dodecanediamine, N¹-(3-aminopropyl)butane-1,4-diamine (spermidine), N¹,N⁶-dimethylhexane-1,6-diamine, 0,0′-bis(3-aminopropyl)polyethylene glycol, polyethyleneamine, or a combination thereof.

In various aspects the polyacid, polyacid ester, polyacyl halide, and/or the one or more polyamines, can be selected to tune the sorbing preference of the polyamide to the one or more metals, such that the one or more metals are sorbed more efficiently, and/or so that one or more additional metals are sorbed less than the one or more metals or not at all.

The polyamide can have any suitable degree of polymerization, such as a degree of polymerization of 2 (e.g., including 2 repetitions of the repeating unit that is derived from the polyacid, polyacid ester, or polyacyl halide) to 1,000,000, or 2 to 1,000, or less than or equal to 1,000,000 and greater than or equal to 2 and less than, equal to, or greater than 3, 4, 5, 6, 7, 8, 9, 10, 12, 14, 16, 18, 20, 25, 30, 35, 40, 45, 50, 60, 70, 80, 90, 100, 125, 150, 175, 200, 250, 300, 350, 400, 450, 500, 600, 700, 800, 900, 1,000, 2,000, 5,000, 10,000, 50,000, 100,000, 500,000, or 750,000. The polyamide can have the structure:

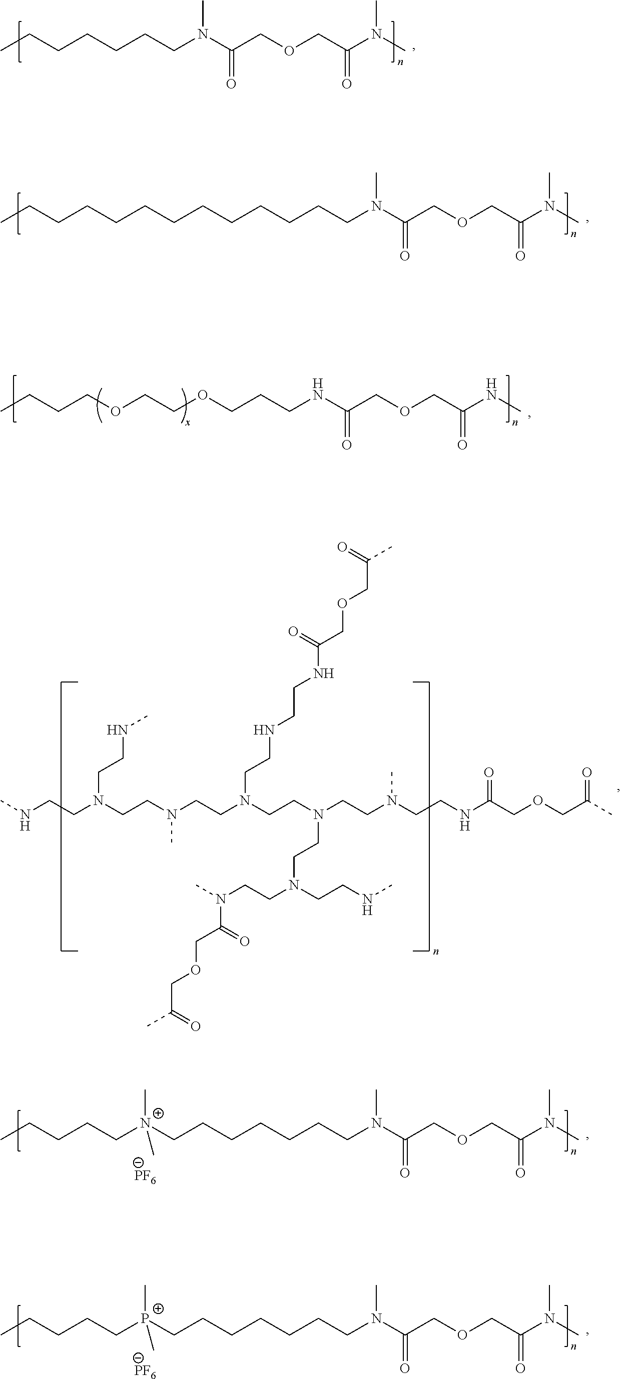

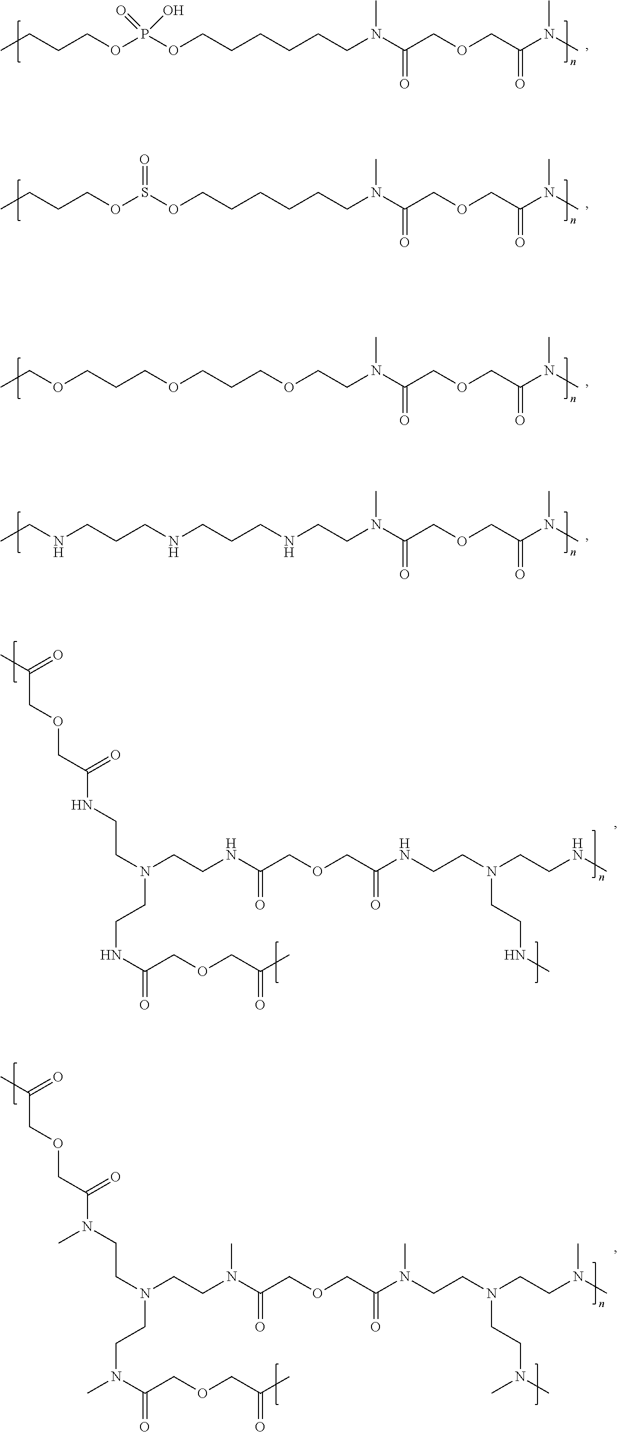

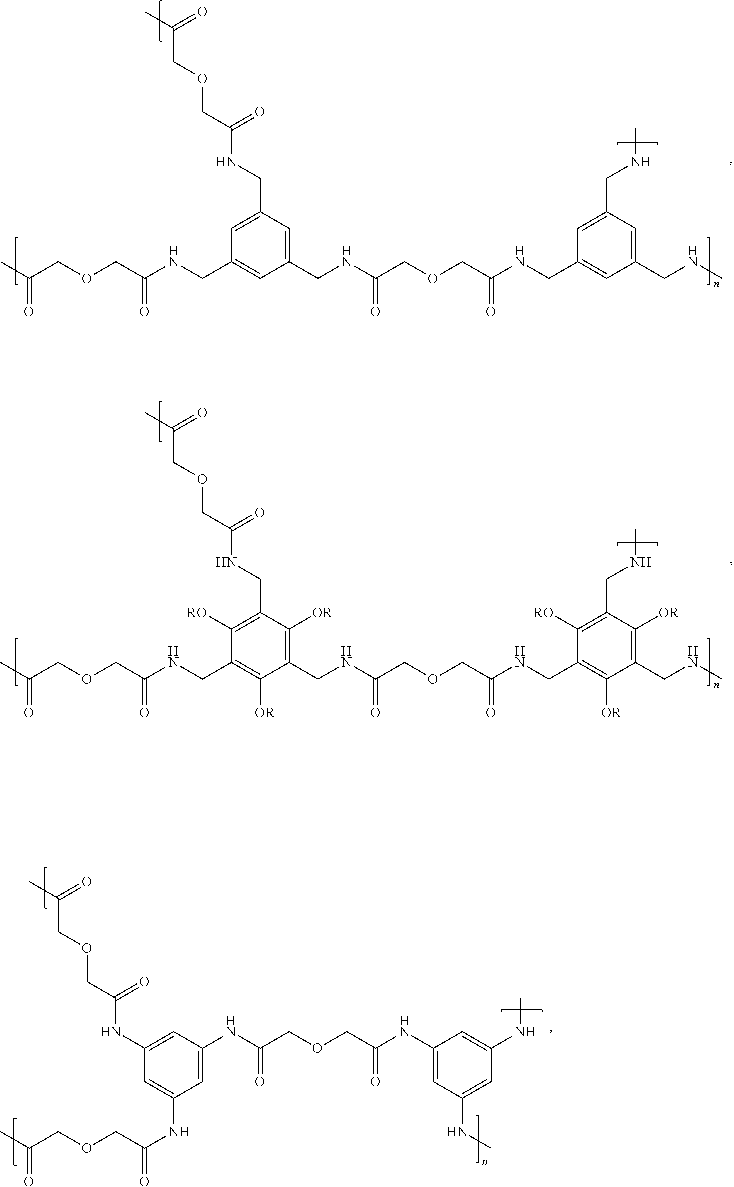

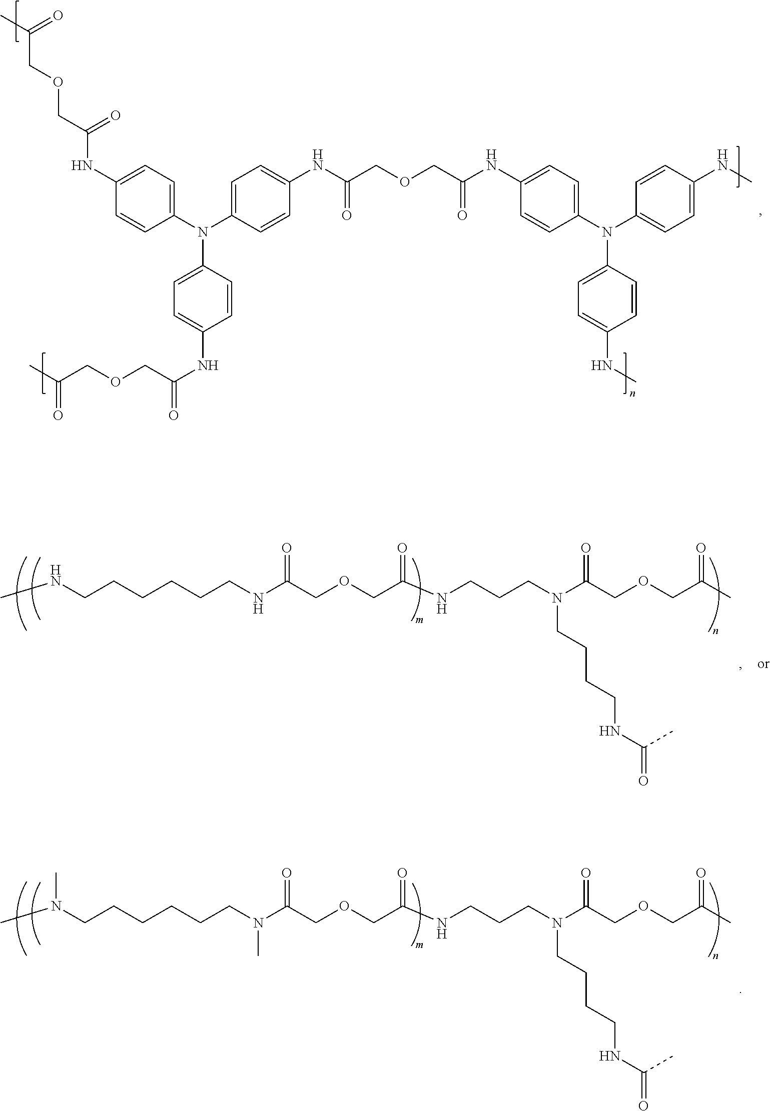

The variable R can be a substituted or unsubstituted (C₁-C₃₀)hydrocarbyl optionally interrupted by 0, 1, 2, or 3 groups independently chosen from —O— and —S—, n can be 2 to 1,000,000 (less than or equal to 1,000,000 and greater than or equal to 2 and less than, equal to, or greater than 3, 4, 5, 6, 7, 8, 9, 10, 12, 14, 16, 18, 20, 25, 30, 35, 40, 45, 50, 60, 70, 80, 90, 100, 125, 150, 175, 200, 250, 300, 350, 400, 450, 500, 600, 700, 800, 900, 1,000, 2,000, 5,000, 10,000, 50,000, 100,000, 500,000, or 750,000), m can be 2 to 1,000,000 (less than or equal to 1,000,000 and greater than or equal to 2 and less than, equal to, or greater than 3, 4, 5, 6, 7, 8, 9, 10, 12, 14, 16, 18, 20, 25, 30, 35, 40, 45, 50, 60, 70, 80, 90, 100, 125, 150, 175, 200, 250, 300, 350, 400, 450, 500, 600, 700, 800, 900, 1,000, 2,000, 5,000, 10,000, 50,000, 100,000, 500,000, or 750,000), and x can be 1 to 1,000,000 (less than or equal to 1,000,000 and greater than or equal to 1 and less than, equal to, or greater than 2, 3, 4, 5, 6, 7, 8, 9, 10, 12, 14, 16, 18, 20, 25, 30, 35, 40, 45, 50, 60, 70, 80, 90, 100, 125, 150, 175, 200, 250, 300, 350, 400, 450, 500, 600, 700, 800, 900, 1,000, 2,000, 5,000, 10,000, 50,000, 100,000, 500,000, or 750,000).

The polyamide can be any suitable proportion of the heterogeneous solution. For example, the polyamide can be 0.001 wt % to 50 wt % of the heterogeneous solution, or 0.1 wt % to 20 wt %, or 1 wt % to 8 wt %, or less than or equal to 50 wt % and greater than or equal to 0.001 wt % and less than, equal to, or greater than 0.005 wt %, 0.01, 0.05, 0.1, 0.5, 1, 1.5, 2, 2.5, 3, 3.5, 4, 4.5, 5, 6, 7, 8, 9, 10, 11, 12, 13, 14, 15, 16, 18, 20, 25, 30, 35, 40, or 45 wt %. The one or more metals can have any suitable concentration in the aqueous solution, such as a concentration of 0.001 mM to 5 M of the aqueous solution, or 0.01 mM to 100 mM, or less than or equal to 5 M and greater than or equal to 0.001 mM and less than, equal to, or greater than 0.005 mM, 0.01, 0.05, 0.1, 0.2, 0.4, 0.6, 0.8, 1, 1.2, 1.4, 1.6, 1.8, 2, 2.5, 3, 4, 5, 6, 7, 8, 9, 10, 12, 14, 16, 18, 20, 25, 30, 35, 40, 45, 50, 60, 70, 80, 90, 100, 120, 140, 160, 180, 200, 250, 300, 350, 400, 450, 500, 600, 700, 800, 900 mM, 1 M, 1.5, 2, 2.5, 3, 3.5, 4, or 4.5 M of the aqueous solution.

The one or more metals can be any suitable one or more metals than can be sorbed by the polyamide. As used herein, sorbed refers to adsorbed and/or absorbed. The one or more metals can be one metal and not more than one metal. The one or more metals can be more than one metal. The one or more metals can include Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof. The one or more metals can include a rare earth metal; for example, the one or more metals can include Sc, Y, La, Ce, Pr, Nd, Sm, Eu, Gd, Tb, Dy, Ho, Er, Tm, Yb, Lu, or a combination thereof. The one or more metals can include a precious metal; for example, the one or more metals can include Rh, Pt, Au, Pd, Ir, Os, Rh, Ru, Ge, Be, Ag, In, Ga, Te, Bi, Hg, or a combination thereof. The one or more metals can include La, Ce, Pr, Nd, Sm, Eu, Gd, Tb, Dy, Ho, Er, Tm, Yb, Lu, Ca, Co, Mg, Mn, Ni, or a combination thereof.

The aqueous solution can include one or more additional metals in addition to the one or more metals, the one or more additional metals including Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof. The one or more additional metals can have any suitable concentration in the aqueous solution and can have a concentration that is greater than, equal to, or less than the concentration of the one or more metals in the aqueous solution. For example, the one or more additional metals can have a concentration in the aqueous solution of 0.001 mM to 5 M of the aqueous solution, or 0.01 mM to 100 mM, or less than or equal to 5 M and greater than or equal to 0.001 mM and less than, equal to, or greater than 0.005 mM, 0.01, 0.05, 0.1, 0.2, 0.4, 0.6, 0.8, 1, 1.2, 1.4, 1.6, 1.8, 2, 2.5, 3, 4, 5, 6, 7, 8, 9, 10, 12, 14, 16, 18, 20, 25, 30, 35, 40, 45, 50, 60, 70, 80, 90, 100, 120, 140, 160, 180, 200, 250, 300, 350, 400, 450, 500, 600, 700, 800, 900 mM, 1 M, 1.5, 2, 2.5, 3, 3.5, 4, or 4.5 M of the aqueous solution. During the sorbing of the one or more metals by the polyamide in the heterogeneous solution, the polyamide can preferentially sorb the one or more metals from the aqueous solution over the one or more additional metals. For example, a weight ratio of the one or more additional metals sorbed to the polyamide to the one or more metals sorbed to the polyamide can be 0:1 to 0.9:1, 0:1 to 0.1:1, or less than or equal to 0.9:1 and greater than or equal to 0:1 and less than, equal to, or greater than 0.001:1, 0.005:1, 0.01:1, 0.05:1, 0.1:1, 0.2:1, 0.3:1, 0.4:1, 0.5:1, 0.6:1, 0.7:1, 0.8:1.

The method can include sorbing any suitable amount of the one or more metals per weight of the polyamide. For example, the polyamide can sorb 0.01 micromoles to 1 mole of the one or more metals per gram of the polyamide, or 0.1 micromoles to 100 micromoles, or less than or equal to 1 mole and greater than or equal to 0.01 micromoles and less than, equal to, or greater than 0.05 micromoles, 0.1, 0.2, 0.3, 0.4, 0.5, 0.6, 0.7, 0.8, 0.9, 1, 1.5, 2, 3, 4, 5, 6, 8, 10, 12, 14, 16, 18, 20, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450, 500, 600, 700, 800, 900 micromoles, 1 millimole, 1.5, 2, 3, 4, 5, 6, 8, 10, 15, 20, 40, 60, 80, 100, 150, 200, 250, 300, 350, 400, 450, 500, 600, 700, 800, or 900 millimoles.

The aqueous solution and the heterogeneous solution can independently have any suitable pH, such as a pH of 0 to 14, 0 to 6.5, or less than or equal to 14 and greater than or equal to 0 and less than, equal to, or greater than 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, or 13.5. The heterogeneous solution can have any temperature during the sorbing of the one or more metals to the polyamide, such as a temperature of 0° C. to 100° C., 15° C. to 30° C., about room temperature, or less than or equal to 100° C. and greater than or equal to 0° C. and less than, equal to, or greater than 5° C., 10, 15, 20, 25, 30, 35, 40, 45, 50, 55, 60, 65, 70, 75, 80, 85, 90, or 95° C. The heterogeneous solution can be maintained at any suitable pressure during the sorbing of the one or more metals to the polyamide, such as a pressure of 0.5 atm to 1.5 atm, or about 1 atm, or less than or equal to 1.5 atm and greater than or equal to 0.5 atm and less than, equal to, or greater than 0.6 atm, 0.7, 0.8, 0.9, 1, 1.1, 1.2, 1.3, or 1.4 atm. The sorbing can be performed for any suitable time period, such as a time of 1 minute to 48 hours, or less than or equal to 48 hours and greater than or equal to 1 minute and less than, equal to, or greater than 2 minutes, 3, 4, 5, 10, 15, 20, 25, 30, 35, 40, 45, 50, 55 minutes, 1 hour, 1.5, 2, 2.5, 3, 3.5, 4, 4.5, 5, 6, 7, 8, 9, 10, 12, 14, 16, 18, 20, 22 hours, 1 day, 1.2, 1.4, 1.6, or 1.8 days. The aqueous solution and the heterogeneous solution can be substantially free of organic solvents, for example, including less than or equal to 1 wt % organic solvents, or 0.5 wt %, 0.1, 0.05, 0.01, 0.005, or less than or equal to 0.001 wt %.

The method can further include forming the aqueous solution that includes the one or more metals therein. Forming the aqueous solution can include dissolving an elemental metal corresponding to the one or more metals in an acidic solution, or dissolving a salt of a metal corresponding to the one or more metals in an aqueous solution that is optionally an acidic solution. The acidic solution can include any suitable acid, such as an organic acid and/or a mineral acid. The acidic solution can include HNO₃, HCl, H₂SO₄, or a combination thereof.

The removal of the polyamide from the heterogeneous solution can be performed in any suitable manner. Removing the polyamide from the heterogeneous solution can include decantation, filtration, centrifugation, sieving, or a combination thereof. Removing the polyamide from the heterogeneous solution can include filtration.

The method can further include removing the one or more metals from the polyamide. The removing of the one or more metals from the polyamide can be performed in any suitable way. For example, removing the one or more metals from the polyamide can include stripping using one or more aqueous solutions having different pH, use of precipitating agents, thermal treatment, or a combination thereof.

The polyamide can have any suitable extraction capacity for the one or more metals, such as an extraction capacity of 0.1 μmol per gram to 500 μmol per gram, or 5 μmol per gram to 100 μmol per gram, or less than or equal to 500 μmol per gram and greater than or equal to 0.1 μmol per gram and less than, equal to, or greater than 0.2, 0.3, 0.4, 0.5, 0.6, 0.7, 0.8, 0.9, 1, 1.2, 1.4, 1.6, 1.8, 2, 2.5, 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 180, 200, 225, 250, 275, 300, 325, 350, 375, 400, 425, 450, or 475 μmol per gram. The method can have any suitable extraction efficiency for the removal of the one or more metals from the aqueous solution, such as an extraction efficiency of 0.1% to 100%, or 1% to 80%, or less than or equal to 100% and greater than or equal to 0.1% and less than, equal to, or greater than 0.5%, 1, 1.5, 2, 2.5, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.5, 99.9, or 99.99%. The post-extracted solution can have any suitable concentration of the one or more metals, such as a concentration that is 0% to 99.9% of the concentration of the one or more metals in the aqueous solution, or 20% to 99%, or less than or equal to 99.9% and greater than or equal to 0%, 0.01, 0.1, 0.5, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, or 99.5% of the concentration of the one or more metals in the aqueous solution.

### Method of Forming a Polyamide.

Various aspects of the present invention provide a method of forming the polyamide used in aspects of the method of extracting one or more metals from the aqueous solution described herein. The method of forming the polyamide can include combining one or more polyamines and a polyacid, polyacid ester, or polyacyl halide to form a reaction mixture including a polymeric ammonium salt. The method can include heating the polymeric ammonium salt to form the polyamide. The heating can include removing water or an alcohol from the polymeric ammonium salt to form the polyamide.

The one or more polyamines and the polyacid, polyacid ester, or polyacyl halide can be combined in an organic solvent, such as (C₁-C₁₀) alcohol, such as ethanol. In other aspects, the polyamide and polyacid can be combined neat.

The method can further include isolating the polymeric ammonium salt from the reaction mixture prior to the heating. The isolating can be performed in any suitable way. For example, the isolating of the polymeric ammonium salt can include filtering the polymeric ammonium salt from the reaction mixture.

The heating of the polymeric ammonium salt can include maintaining the ammonium salt at any suitable temperature, such as a temperature of 100° C. to 1000° C., or 150° C. to 250° C., or less than or equal to 1000° C. and greater than or equal to 100° C. and less than, equal to, or greater than 120° C., 140, 160, 180, 200, 220, 240, 260, 280, 300, 350, 400, 450, 500, 600, 700, 800, or 900° C. The heating can include heating the ammonium salt under an inert atmosphere, vacuum, or a combination thereof. The inert atmosphere can include a nitrogen atmosphere. The heating can include heating the ammonium salt under an inert atmosphere and then heating the ammonium salt under vacuum to substantially complete the removal of water and/or alcohol therefrom.

### EXAMPLES

Various aspects of the present invention can be better understood by reference to the following Examples which are offered by way of illustration. The present invention is not limited to the Examples given herein.

### Example 1. Polymeric DGA Synthesis Via Melt Amidation

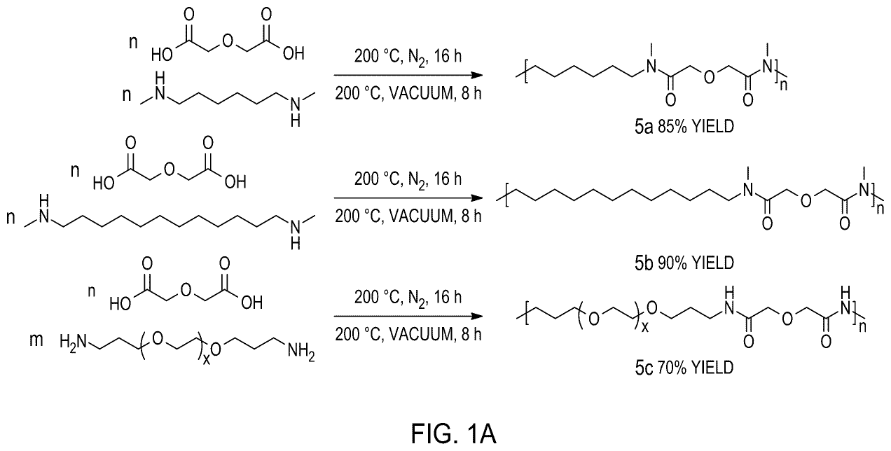

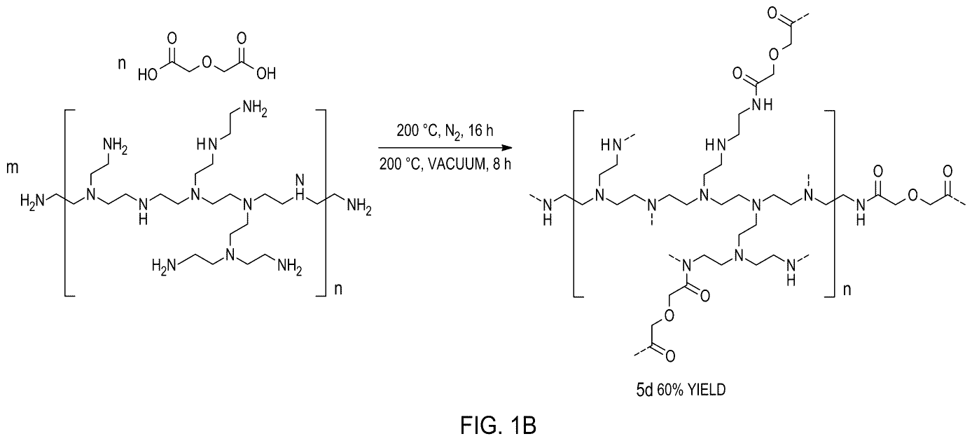

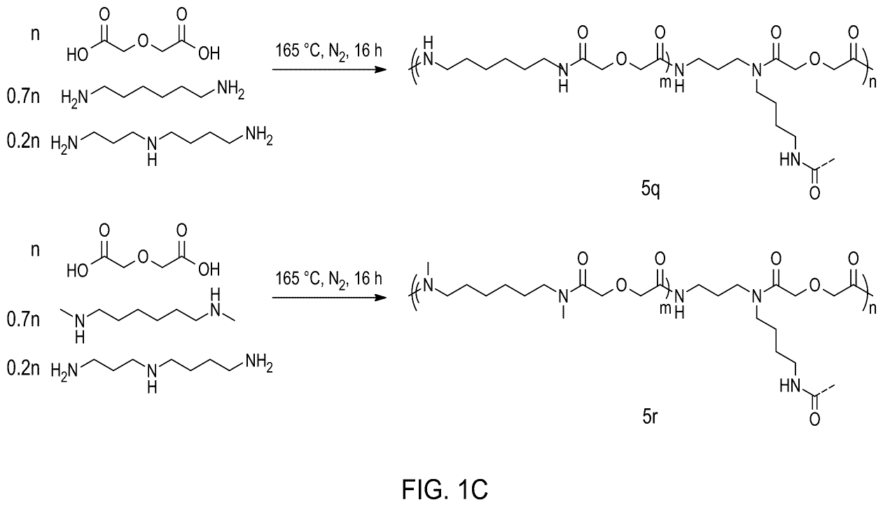

Four PDGAs were synthesized using diglycolic acid as the diacid (FIGS. 1A-1B). The di-/poly-amines included hexamethylenediamine, 1,12-dodecanediamine, 0,0′-bis(3-aminopropyl)polyethylene glycol (average Mn 1,500), and polyethyleneimine (PEI, average Mn 1,800). Initially, a mixture of the di-/poly-amine and diglycolic acid in ethanol was stirred at room temperature for 12 hours to form the corresponding ammonium salt, which was then isolated by filtration. The ammonium salts were transferred to a 50 mL round bottom flask and heated to 200° C. to prepare the PDGAs. To ensure complete conversion of the starting materials and achieve high molecular weight products, we first heated the reaction mixture at 200° C. under flowing N₂ for 16 hours, followed by an additional 8 hours under high vacuum.

The yields and physical states of the PDGAs were as follows:

5a: A pale yellow viscous oil obtained in 85% yield from the ammonium salt prepared by diglycolic acid (1.34 g, 10.0 mmol) and hexamethylenediamine (1.16 g, 10.0 mmol).

5b: A brown viscous oil obtained in 90% yield from the ammonium salt prepared by diglycolic acid (1.34 g, 10.0 mmol) and 1,12-dodecanediamine (2.0 g, 10.0 mmol).

5c: A brown viscous oil obtained in 70% yield from the ammonium salt prepared by diglycolic acid (0.44 g, 3.3 mmol) and 0,0′-bis(3-aminopropyl)polyethylene glycol (5.0 g, 6.6 mmol ‘NH₂’).

5d: A dark brown viscous oil obtained in 60% yield from the ammonium salt prepared by diglycolic acid (7.9 g, 59.0 mmol) and polyethyleneimine (PEI, average Mn 1,800, 5.0 g, 118 mmol ‘NH₂’).

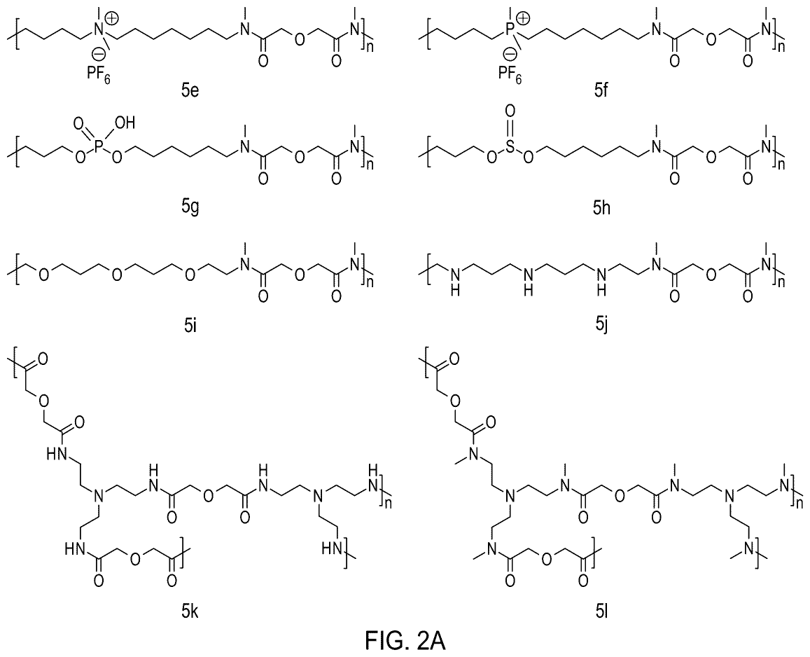

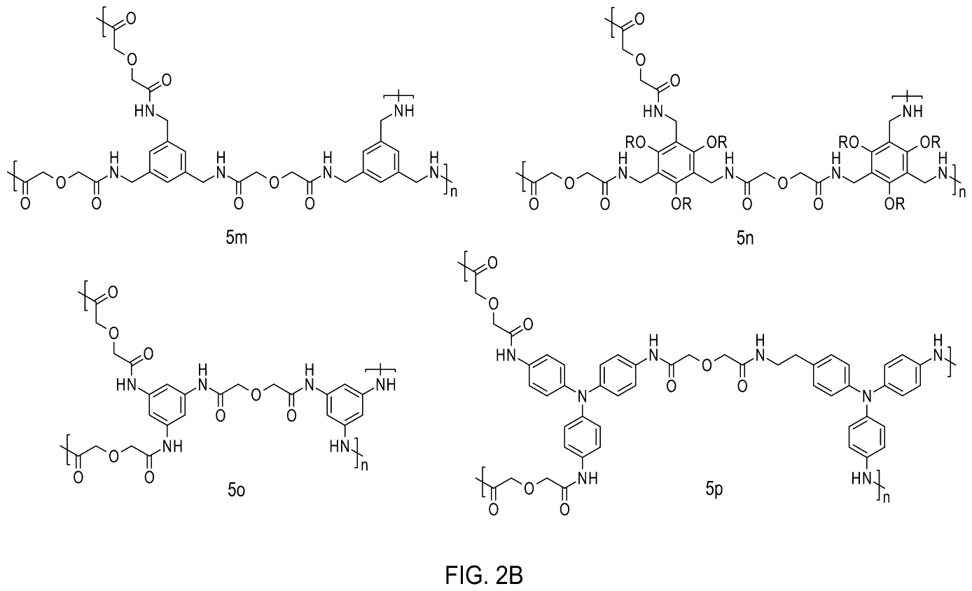

The melt-polymerization synthetic methods can be generalized for various polymeric DGAs with different linkers and functionalities (5e to 5p), as illustrated in FIGS. 2A-2B.

In addition to diglycolic acid, other di-/poly-acids can also be used in this study, including but not limited to alkane diacids (e.g., oxalic acid, malonic acid, succinic acid, glutaric acid, adipic acid, pimelic acid, and the like), tricarboxylic acids (e.g., citric acid), and other polyacid (e.g., polyacrylic acid, polymethacrylic acid, and the like).

### Example 2. REE Extraction Studies with Polymeric DGAs

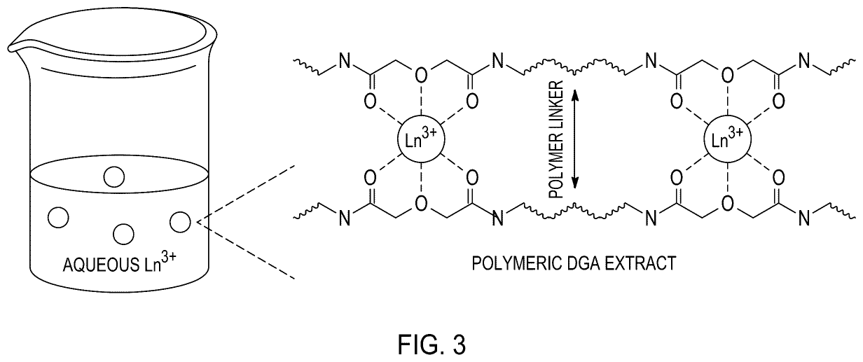

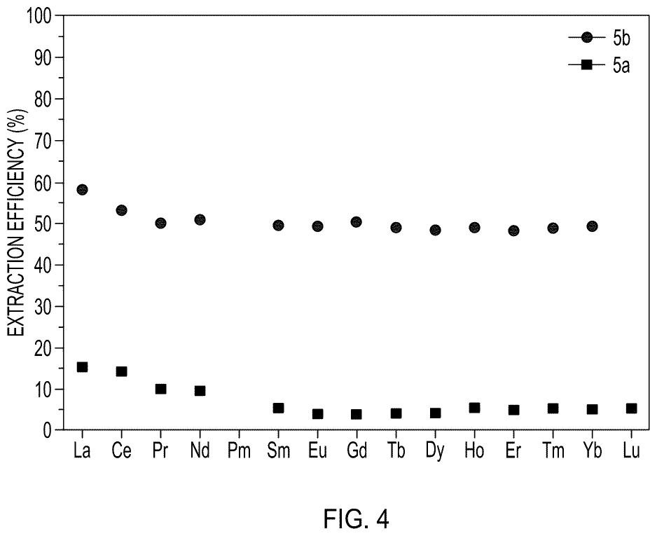

Solid-liquid extraction (SLE) experiments were conducted using polymeric DGAs 5a and 5b in organic solvent-free conditions. In a 15 mL centrifuge tube, 5 mL of 0.5 mM of each of 14 lanthanide (Ln) nitrate salt in 3 M HNO₃ was mixed with 190 mg of 5a or 250 mg of 5b. The extraction mixture was allowed to stand statically at 22±1° C. for 6 hours. Afterward, 1 mL of the aqueous solution was filtered and further diluted with 5 mL of 2 volume % HNO₃ for inductively coupled plasma (ICP) analysis to determine the Ln concentration in the post-extraction solution. Preliminary results indicate that 5b, with longer dodecyl linkers, achieved extraction efficiencies (calculated as (concentration of metal in extract/concentration of metal in original sample)×100%) exceeding 50% for all 14 tested lanthanides. This corresponds to an extraction capacity of 71 μmol of total lanthanides per gram of polymer 5b. In contrast, PDGA 5a, with shorter hexyl linkers, exhibited extraction efficiencies of less than 10%. FIG. 3 illustrates sorption of lanthanides with the polymeric diglycolamide. FIG. 4 illustrates extraction efficiency for various lanthanides using polymeric DGAs 5a and 5b.

### Example 3. Polymeric DGA Synthesis Via Melt Amidation

Two cross-linked PDGAs were synthesized using diglycolic acid as the diacid and N¹-(3-aminopropyl)butane-1,4-diamine (spermidine) as the amine cross-linker (FIG. 1C). The diamines employed were hexane-1,6-diamine (for 5q) and N¹,N⁶-dimethylhexane-1,6-diamine (for 5r). The synthesis procedure was similar to that used in Example 1. Briefly, a mixture containing 1.0 equivalent of diglycolic acid, 0.7 equivalent of the diamine, and 0.2 equivalent of spermidine in ethanol was stirred at room temperature for 12 hours to form the corresponding ammonium salt. The precipitated salt was collected by centrifugation and washed three times with diethyl ether. The ammonium salts were then transferred to a 20 mL scintillation vial and heated at 165° C. under N₂ for 16 hours to yield the cross-linked PDGAs. The resulting materials were directly used for subsequent REE extraction studies.

### Example 4. Main Group and Transition Metals Extraction Studies with Polymeric DGAs

The extraction capabilities of as-synthesized PDGAs from Example 1 were further evaluated for both main group and transition metals, using calcium (Ca), magnesium (Mg), manganese (Mn), cobalt (Co), and nickel (Ni) as representative elements.

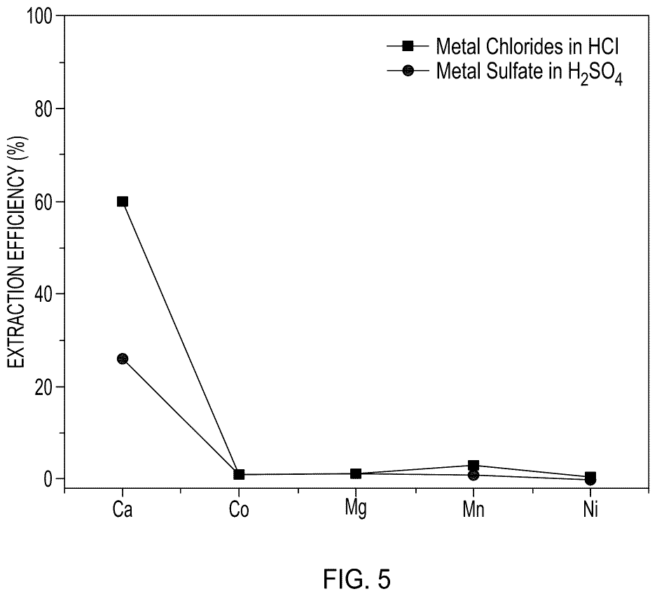

A solution of 0.5 mM of metal chlorides or sulfates in 3.0 M HCl (5.00 mL) or 1.5 M H₂SO₄ (5.00 mL), respectively, was mixed with 200 mg of DGA polymer 5b. This mixture was maintained at room temperature (22±1° C.) for 6 hours without stirring. Subsequently, the aqueous solution was filtered, and 1.00 mL of this filtered solution was further diluted with 5.00 mL of 4% HNO₃ for ICP analysis. FIG. 5 illustrates the extraction efficiency for DGA polymer 5b for the tested metals in HCl or H₂SO₄. Among the tested metals (Ca, Co, Mg, Mn, and Ni), compound 5b shows substantial extraction efficiency only for Ca, reaching 60%. This corresponds to an extraction capacity of 7.5 μmol of calcium per gram of polymer 5b.

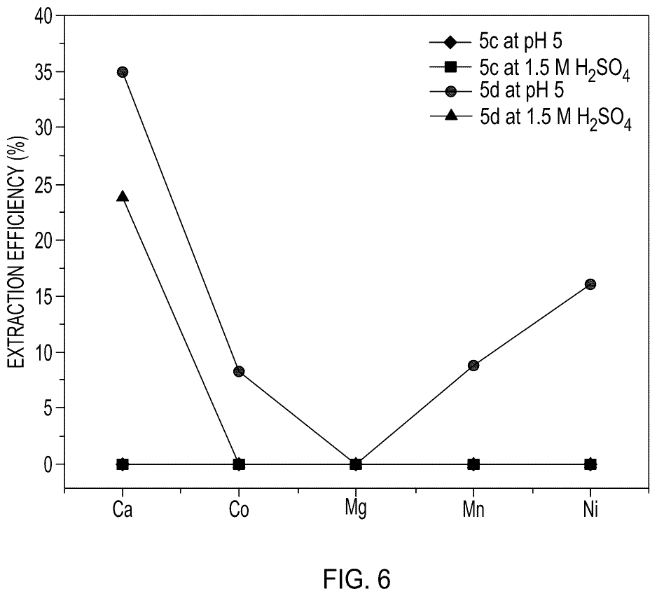

A similar procedure was followed using 0.5 mM of metal sulfates in either 1.5 M H₂SO₄ (4 mL) or pH 5.0 H₂SO₄ (0.00001 M) solution (4 mL), with 200 mg of DGA polymers 5c or 5d. The mixture was left at room temperature (22±1° C.) for 6 hours without stirring, after which the aqueous solution was filtered, and 1.00 mL of the filtered solution was again diluted with 5.00 mL of 4% HNO₃ for ICP analysis. FIG. 6 illustrates extraction efficiency for DGA polymers 5c and 5d for the various tested metals using 1.5 M H₂SO₄ or pH 5 H₂SO₄ solution. Negligible extraction behavior was observed for compound 5c. In the extraction studies of polymer 5d, acid concentration was found to be a significant factor, with the polymer demonstrating moderate extraction efficiency for Ca (3.5 μmol/g), Co (0.8 μmol/g), Mn (0.9 μmol/g), and Ni (1.6 μmol/g) at lower acid concentrations (0.00001 M H₂SO₄, pH 5). Notably, only Ca was extracted (2.4 μmol/g) at a high concentration of sulfuric acid (1.5 M).

### Example 5. Lanthanide Extraction Studies with Polymeric DGAs

The lanthanide extraction capabilities of as-synthesized PDGAs from Example 3 were evaluated. Solid-liquid extraction (SLE) was conducted using the cross-linked polymeric DGAs 5q and 5r following a modified procedure based on that used in Example 2. In a 20 mL scintillation vial, 5 mL of 0.5 mM of each of 14 lanthanide nitrate salt in 3.0 M HNO₃ was combined with 171 mg of 5q or 185 mg of 5r. The mixture was stirred at room temperature for 6 hours. After extraction, 1 mL of the aqueous phase was filtered and diluted with 5 mL of 2 volume % HNO₃ for ICP-OES analysis to quantify the lanthanide concentrations in the post-extraction solutions.

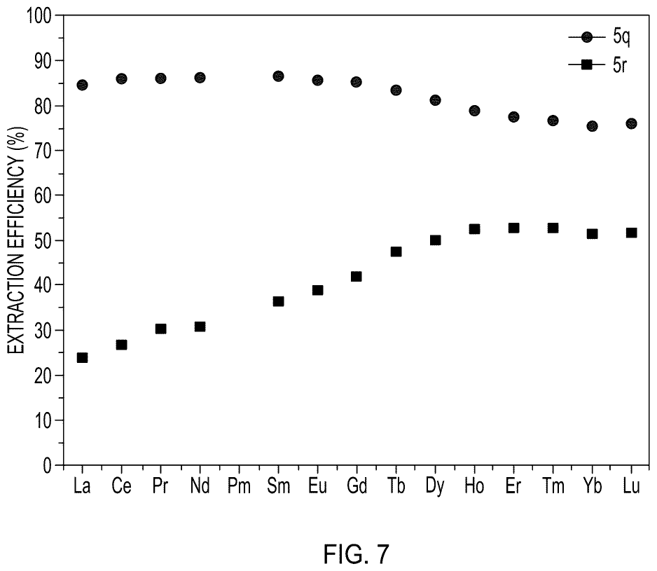

Preliminary results show that the cross-linked 5q achieved extraction efficiencies exceeding 20% for all 14 lanthanides tested (FIG. 7), corresponding to an extraction capacity of 86 μmol of total lanthanides per gram of polymer. In comparison, polymer 5r, which incorporates additional methyl substituents on the amide groups, exhibited improved extraction efficiencies of over 70% across all lanthanides, yielding an extraction capacity of 155 μmol of total lanthanides per gram of polymer.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides a method of extracting one or more metals from an aqueous solution, the method comprising:
forming a heterogeneous solution comprising a polyamide and the aqueous solution comprising the one or more metals therein, such that the polyamide sorbs at least some of the one or more metals in the aqueous solution; and
removing the polyamide from the heterogeneous solution to form a post-extracted solution having a lower concentration of the one or more metals than the aqueous solution;
wherein the polyamide is an amidization product of one or more polyamines and a polyacid, polyacid ester, or polyacyl halide.

Aspect 2 provides the method of Aspect 1, wherein the one or more metals are one or more dissolved metals.

Aspect 3 provides the method of any one of Aspects 1-2, wherein the polyamide is a solid polyamide that is substantially free of dissolution in the aqueous solution.

Aspect 4 provides the method of any one of Aspects 1-3, wherein the polyamide is a polymeric diglycolamide.

Aspect 5 provides the method of any one of Aspects 1-4, wherein the polyacid or ester is a diacid or a diester.

Aspect 6 provides the method of any one of Aspects 1-5, wherein the polyacid or ester is diglycolic acid, oxalic acid, malonic acid, succinic acid, glutaric acid, adipic acid, pimelic acid, a substituted or unsubstituted (C₁-C₃₀)hydrocarbyl ester derived therefrom, or a combination thereof.

Aspect 7 provides the method of any one of Aspects 1-6, wherein the polyacid or ester is a triacid or a triester.

Aspect 8 provides the method of any one of Aspects 1-7, wherein the polyacid or ester is citric acid, a substituted or unsubstituted (C₁-C₃₀)hydrocarbyl ester derived therefrom, or a combination thereof.

Aspect 9 provides the method of any one of Aspects 1-8, wherein the polyacid or ester is polyacrylic acid, polymethacrylic acid, a substituted or unsubstituted (C₁-C₃₀)hydrocarbyl ester derived therefrom, or a combination thereof.

Aspect 10 provides the method of any one of Aspects 1-9, wherein the polyacid or ester is a diglycolic acid or ester having the structure R³O—C(O)—CH(R¹)—O—CH(R²)—C(O)—OR⁴, R³ and R⁴ are independently chosen from —H and a substituted or unsubstituted (C₁-C₃₀)hydrocarbyl optionally interrupted by 0, 1, 2, or 3 groups independently chosen from —O— and —S—, and R¹ and R² are independently chosen from —H and a substituted or unsubstituted (C₁-C₃₀)hydrocarbyl optionally interrupted by 0, 1, 2, or 3 groups independently chosen from —O— and —S—.

Aspect 11 provides the method of Aspect 10, wherein R¹, R², R³, and R⁴ are —H,

Aspect 12 provides the method of any one of Aspects 1-11, wherein the polyamine is a diamine.

Aspect 13 provides the method of any one of Aspects 1-12, wherein the polyamine has greater than two amine groups.

Aspect 14 provides the method of any one of Aspects 1-13, wherein the polyamine is hexamethylenediamine, 1,12-dodecanediamine, N¹-(3-aminopropyl)butane-1,4-diamine (spermidine), N¹,N⁶-dimethylhexane-1,6-diamine, O,O′-bis(3-aminopropyl)polyethylene glycol, polyethyleneamine,

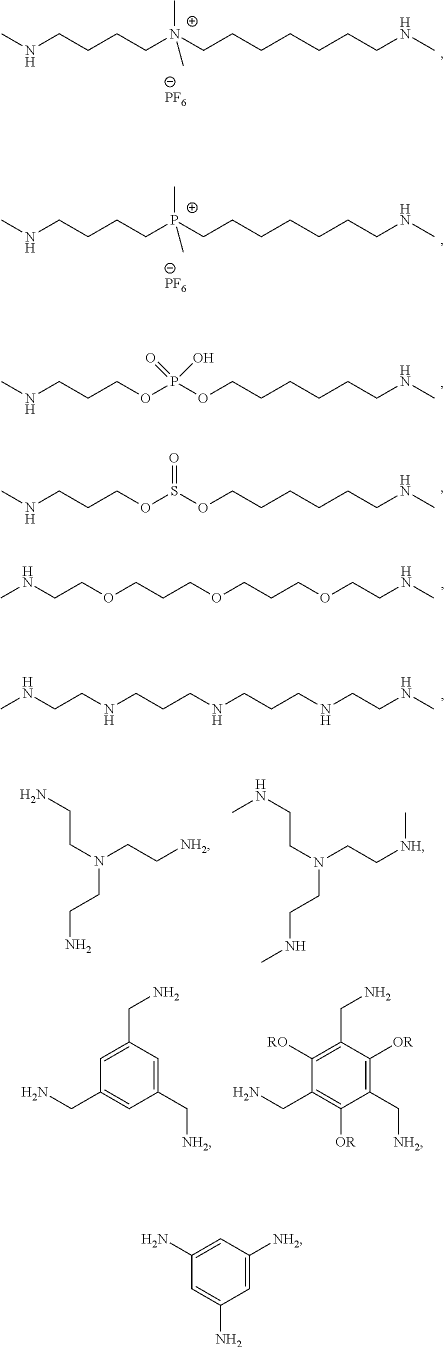

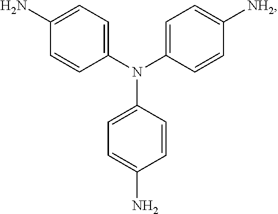 [SMILES: Nc1ccc(N(c2ccc(N)cc2)c2ccc(N)cc2)cc1]

or a combination thereof, wherein R is a substituted or unsubstituted (C₁-C₃₀)hydrocarbyl optionally interrupted by 0, 1, 2, or 3 groups independently chosen from —O— and —S—, n is 2 to 1,000,000, and x is 1 to 1,000,000.

Aspect 15 provides the method of any one of Aspects 1-14, wherein the polyamine is hexamethylenediamine, 1,12-dodecanediamine, Ni-(3-aminopropyl)butane-1,4-diamine (spermidine), N¹,N⁶-dimethylhexane-1,6-diamine, O,O′-bis(3-aminopropyl)polyethylene glycol, polyethyleneamine, or a combination thereof.

Aspect 16 provides the method of any one of Aspects 1-15, wherein the polyacid or ester is diglycolic acid or a substituted or unsubstituted (C₁-C₃₀)hydrocarbyl ester derived therefrom.

Aspect 17 provides the method of any one of Aspects 1-16, wherein the polyamide has a degree of polymerization of 2 to 1,000,000.

Aspect 18 provides the method of any one of Aspects 1-17, wherein the polyamide has the structure:

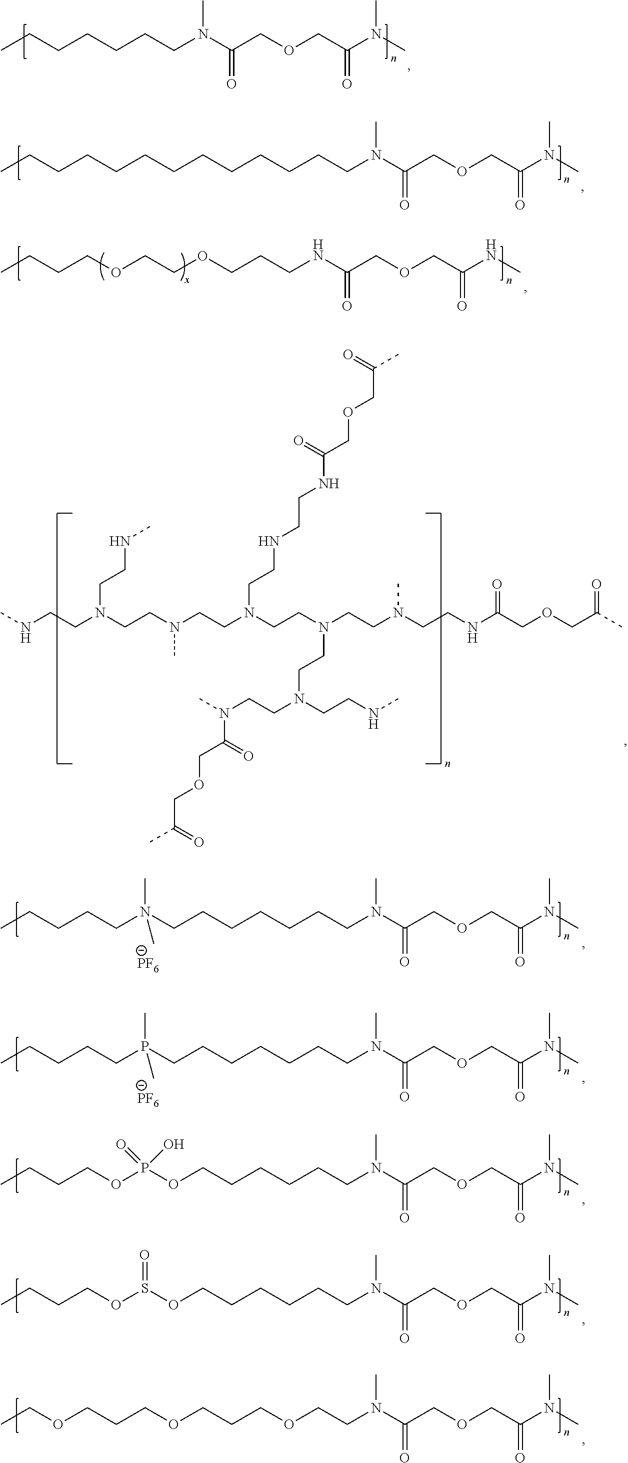

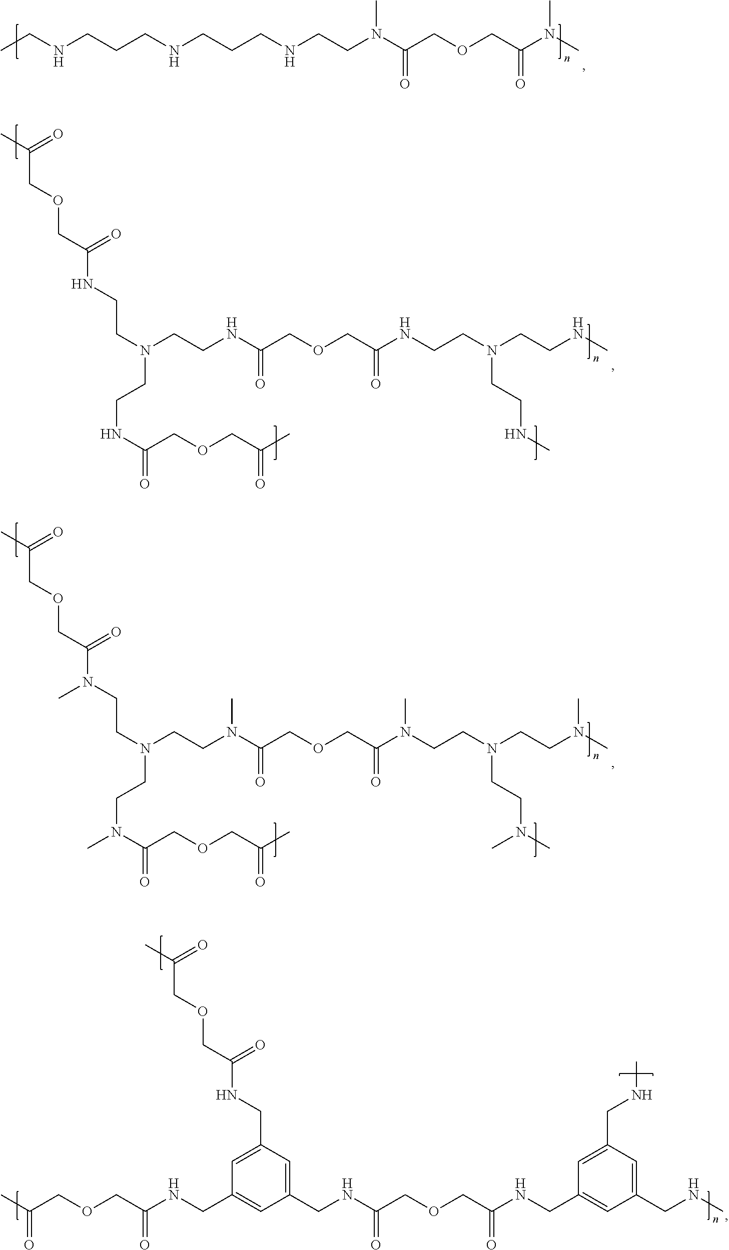

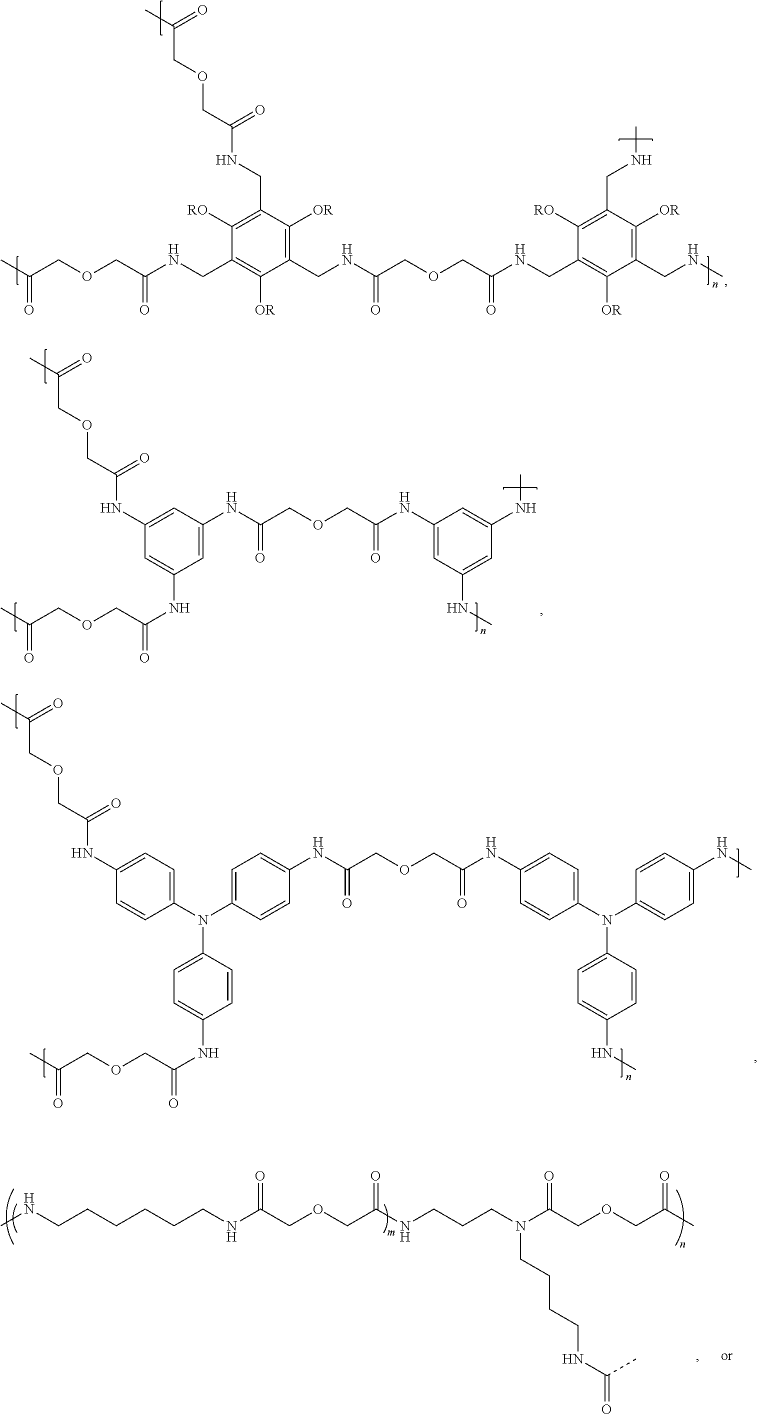

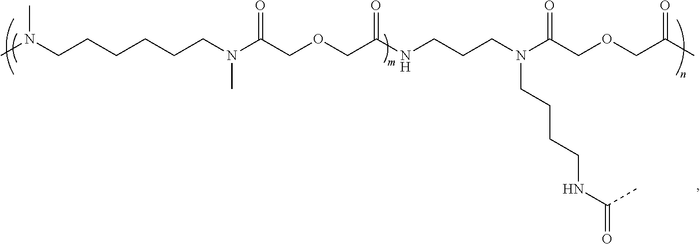

wherein R is a substituted or unsubstituted (C₁-C₃₀)hydrocarbyl optionally interrupted by 0, 1, 2, or 3 groups independently chosen from —O— and —S—, n is 2 to 1,000,000, m is 2 to 1,000,000, and x is 1 to 1,000,000.

Aspect 19 provides the method of any one of Aspects 1-18, wherein the polyamide is 0.001 wt % to 50 wt % of the heterogeneous solution.

Aspect 20 provides the method of any one of Aspects 1-19, wherein the polyamide is 0.1 wt % to 20 wt % of the heterogeneous solution.

Aspect 21 provides the method of any one of Aspects 1-20, wherein the one or more metals have a concentration of 0.001 mM to 5 M in the aqueous solution.

Aspect 22 provides the method of any one of Aspects 1-21, wherein the one or more metals have a concentration of 0.01 mM to 100 mM in the aqueous solution.

Aspect 23 provides the method of any one of Aspects 1-22, wherein the one or more metals are one metal and not more than one metal.

Aspect 24 provides the method of any one of Aspects 1-23, wherein the one or more metals are more than one metal.

Aspect 25 provides the method of any one of Aspects 1-24, wherein the one or more metals comprise Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof.

Aspect 26 provides the method of any one of Aspects 1-25, wherein the aqueous solution comprises one or more additional metals in addition to the one or more metals, the one or more additional metals comprising Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof.

Aspect 27 provides the method of Aspect 26, wherein the one or more additional metals have a concentration of 0.001 mM to 5 M in the aqueous solution.

Aspect 28 provides the method of any one of Aspects 26-27, wherein the one or more additional metals have a concentration of 0.01 mM to 100 mM in the aqueous solution.

Aspect 29 provides the method of any one of Aspects 26-28, wherein the polyamide preferentially sorbs the one or more metals from the aqueous solution over the one or more additional metals.

Aspect 30 provides the method of Aspect 29, wherein a weight ratio of the one or more additional metals sorbed to the polyamide to the one or more metals sorbed to the polyamide is 0:1 to 0.9:1.

Aspect 31 provides the method of any one of Aspects 29-30, wherein a weight ratio of the one or more additional metals sorbed to the polyamide to the one or more metals sorbed to the polyamide is 0:1 to 0.1:1.

Aspect 32 provides the method of any one of Aspects 1-31, wherein the one or more metals comprise a rare earth metal.

Aspect 33 provides the method of Aspect 32, wherein the one or more metals comprise Sc, Y, La, Ce, Pr, Nd, Sm, Eu, Gd, Tb, Dy, Ho, Er, Tm, Yb, Lu, or a combination thereof.

Aspect 34 provides the method of any one of Aspects 1-33, wherein the one or more metals comprise a precious metal.

Aspect 35 provides the method of Aspect 34, wherein the one or more metals comprise Rh, Pt, Au, Pd, Ir, Os, Rh, Ru, Ge, Be, Ag, In, Ga, Te, Bi, Hg, or a combination thereof.

Aspect 36 provides the method of any one of Aspects 1-35, wherein the one or more metals comprise La, Ce, Pr, Nd, Sm, Eu, Gd, Tb, Dy, Ho, Er, Tm, Yb, Lu, Ca, Co, Mg, Mn, Ni, or a combination thereof.

Aspect 37 provides the method of any one of Aspects 1-36, wherein the polyamide sorbs 0.01 micromoles to 1 mole of the one or more metals per gram of the polyamide.

Aspect 38 provides the method of any one of Aspects 1-37, wherein the polyamide sorbs 0.1 micromoles to 100 micromoles of the one or more metals per gram of the polyamide.

Aspect 39 provides the method of any one of Aspects 1-38, wherein the aqueous solution and the heterogeneous solution has a pH of 0 to 14.

Aspect 40 provides the method of any one of Aspects 1-39, wherein the aqueous solution and the heterogeneous solution has a pH of 0 to 6.5.

Aspect 41 provides the method of any one of Aspects 1-40, wherein the heterogeneous solution has a temperature of 0° C. to 100° C. during the sorbing of the one or more metals to the polyamide.

Aspect 42 provides the method of any one of Aspects 1-41, wherein the heterogeneous solution has a temperature of 15° C. to 30° C. during the sorbing of the one or more metals to the polyamide.

Aspect 43 provides the method of any one of Aspects 1-42, wherein the heterogeneous solution has a pressure of 0.5 atm to 1.5 atm during the sorbing of the one or more metals to the polyamide.

Aspect 44 provides the method of any one of Aspects 1-43, wherein the heterogeneous solution has a pressure of about 1 atm during the sorbing of the one or more metals to the polyamide.

Aspect 45 provides the method of any one of Aspects 1-44, wherein the aqueous solution and the heterogeneous solution are substantially free of organic solvents.

Aspect 46 provides the method of any one of Aspects 1-45, further comprising forming the aqueous solution.

Aspect 47 provides the method of Aspect 46, wherein forming the aqueous solution comprises dissolving an elemental metal corresponding to the one or more metals or a salt of a metal corresponding to the one or more metals in an acidic solution.

Aspect 48 provides the method of Aspect 47, wherein the acidic solution comprises an organic acid, a mineral acid, or a combination thereof.

Aspect 49 provides the method of any one of Aspects 47-48, wherein the acidic solution comprises HNO₃, HCl, H₂SO₄, or a combination thereof.

Aspect 50 provides the method of any one of Aspects 1-49, wherein removing the polyamide from the heterogeneous solution comprises decantation, filtration, centrifugation, sieving, or a combination thereof.

Aspect 51 provides the method of any one of Aspects 1-50, wherein removing the polyamide from the heterogeneous solution comprises filtration.

Aspect 52 provides the method of any one of Aspects 1-51, further comprising removing the one or more metals from the polyamide.

Aspect 53 provides the method of Aspect 52, wherein removing the one or more metals from the polyamide comprises stripping using one or more aqueous solutions having different pH, use of precipitating agents, thermal treatment, or a combination thereof.

Aspect 54 provides a method of forming the polyamide of any one of Aspects 1-53, the method comprising:
combining one or more polyamines and a polyacid, polyacid ester, or polyacyl halide to form a reaction mixture comprising a polymeric ammonium salt; and
heating the polymeric ammonium salt to form the polyamide.

Aspect 55 provides the method of Aspect 54, wherein the one or more polyamines and the polyacid, polyacid ester, or polyacyl halide are combined in an organic solvent.

Aspect 56 provides the method of Aspect 55, wherein the organic solvent is ethanol.

Aspect 57 provides the method of any one of Aspects 54-56, further comprising isolating the polymeric ammonium salt from the reaction mixture prior to the heating.

Aspect 58 provides the method of Aspect 57, wherein isolating the polymeric ammonium salt comprises filtering the polymeric ammonium salt from the reaction mixture.

Aspect 59 provides the method of any one of Aspects 54-58, wherein the heating comprises maintaining the ammonium salt at a temperature of 100° C. to 1000° C.

Aspect 60 provides the method of any one of Aspects 54-59, wherein the heating comprises maintaining the ammonium salt at a temperature of 150° C. to 250° C.

Aspect 61 provides the method of any one of Aspects 54-60, wherein the heating comprises heating the ammonium salt under an inert atmosphere, vacuum, or a combination thereof.

Aspect 62 provides the method of Aspect 61, wherein the inert atmosphere comprises a nitrogen atmosphere.

Aspect 63 provides the method of any one of Aspects 54-62, wherein the heating comprises heating the ammonium salt under an inert atmosphere and then heating the ammonium salt under vacuum.

Aspect 64 provides a method of extracting one or more metals from an aqueous solution, the method comprising:
forming a heterogeneous solution comprising a solid polyamide and the aqueous solution comprising the one or more metals therein, such that the polyamide sorbs at least some of the one or more metals in the aqueous solution, wherein the one or more metals comprise La, Ce, Pr, Nd, Sm, Eu, Gd, Tb, Dy, Ho, Er, Tm, Yb, Lu, Ca, Co, Mg, Mn, Ni, or a combination thereof, and
removing the polyamide from the heterogeneous solution to form a post-extracted solution having a lower concentration of the one or more metals than the aqueous solution;
wherein the polyamide is an amidization product of one or more polyamines and diglycolic acid.

Aspect 65 provides the method of any one or any combination of Aspects 1-64 optionally configured such that all elements or options recited are available to use or select from.

What is claimed is:

1. A method of extracting one or more metals from an aqueous solution, the method comprising:
forming a heterogeneous solution comprising a polyamide and the aqueous solution comprising the one or more metals therein, such that the polyamide sorbs at least some of the one or more metals in the aqueous solution; and
removing the polyamide from the heterogeneous solution to form a post-extracted solution having a lower concentration of the one or more metals than the aqueous solution;
wherein the polyamide is an amidization product of one or more polyamines and a polyacid, polyacid ester, or polyacyl halide.

2. The method of claim 1, wherein the polyacid, polyacid halide, or polyacyl halide is a diacid, a diester, a diacyl halide, a triacid, a triester, a triacyl halide, a polyacid having more than three acid groups, a polyester having more than three ester groups, or a polyacyl haide having more than three acyl halide groups.

3. The method of claim 1, wherein the polyacid, polyacid ester, or polyacyl halide is diglycolic acid, oxalic acid, malonic acid, succinic acid, glutaric acid, adipic acid, pimelic acid, citric acid, polyacrylic acid, polymethacrylic acid, a substituted or unsubstituted (C₁-C₃₀)hydrocarbyl ester derived therefrom, a diglycolyl halide, malonyl halide, succinyl halide, glutaryl halide, adipyl halide, pimelyl halide, citryl halide, polyacrylyl halide, polymethacrylyl halide, or a combination thereof.

4. The method of claim 1, wherein the polyacid, polyacid ester, or polyacyl halide is a diglycolic acid or an ester having the structure R³O—C(O)—CH(R¹)—O—CH(R²)—C(O)—OR⁴ or a diglycolyl halide having the structure X—C(O)—CH(R¹)—O—CH(R²)—C(O)—X, X is halide, R³ and R⁴ are independently chosen from —H and a substituted or unsubstituted (C₁-C₃₀)hydrocarbyl optionally interrupted by 0, 1, 2, or 3 groups independently chosen from —O— and —S—, and R¹ and R² are independently chosen from —H and a substituted or unsubstituted (C₁-C₃₀)hydrocarbyl optionally interrupted by 0, 1, 2, or 3 groups independently chosen from —O— and —S—.

5. The method of claim 1, wherein the polyamine is hexamethylenediamine, 1,12-dodecanediamine, N¹-(3-aminopropyl)butane-1,4-diamine (spermidine), N¹,N⁶-dimethylhexane-1,6-diamine, O,O′-bis(3-aminopropyl)polyethylene glycol, polyethyleneamine, 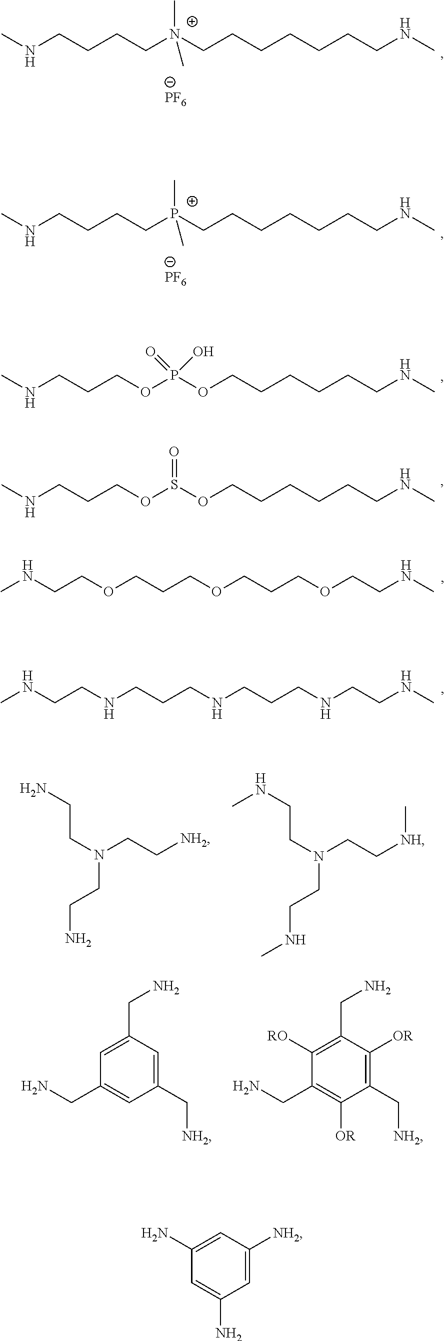 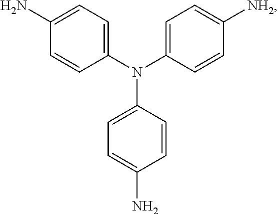 [SMILES: Nc1ccc(N(c2ccc(N)cc2)c2ccc(N)cc2)cc1]
or a combination thereof, wherein R is a substituted or unsubstituted (C₁-C₃₀)hydrocarbyl optionally interrupted by 0, 1, 2, or 3 groups independently chosen from —O— and —S—, n is 2 to 1,000,000, and x is 1 to 1,000,000.

6. The method of claim 1, wherein the polyacid, polyacid ester, or polyacyl halide is diglycolic acid, a substituted or unsubstituted (C₁-C₃₀)hydrocarbyl ester derived therefrom, or a diglycolyl halide, and wherein the polyamide is a polymeric diglycolamide.

7. The method of claim 1, wherein the polyamide has a degree of polymerization of 2 to 1,000,000.

8. The method of claim 1, wherein the polyamide has the structure: 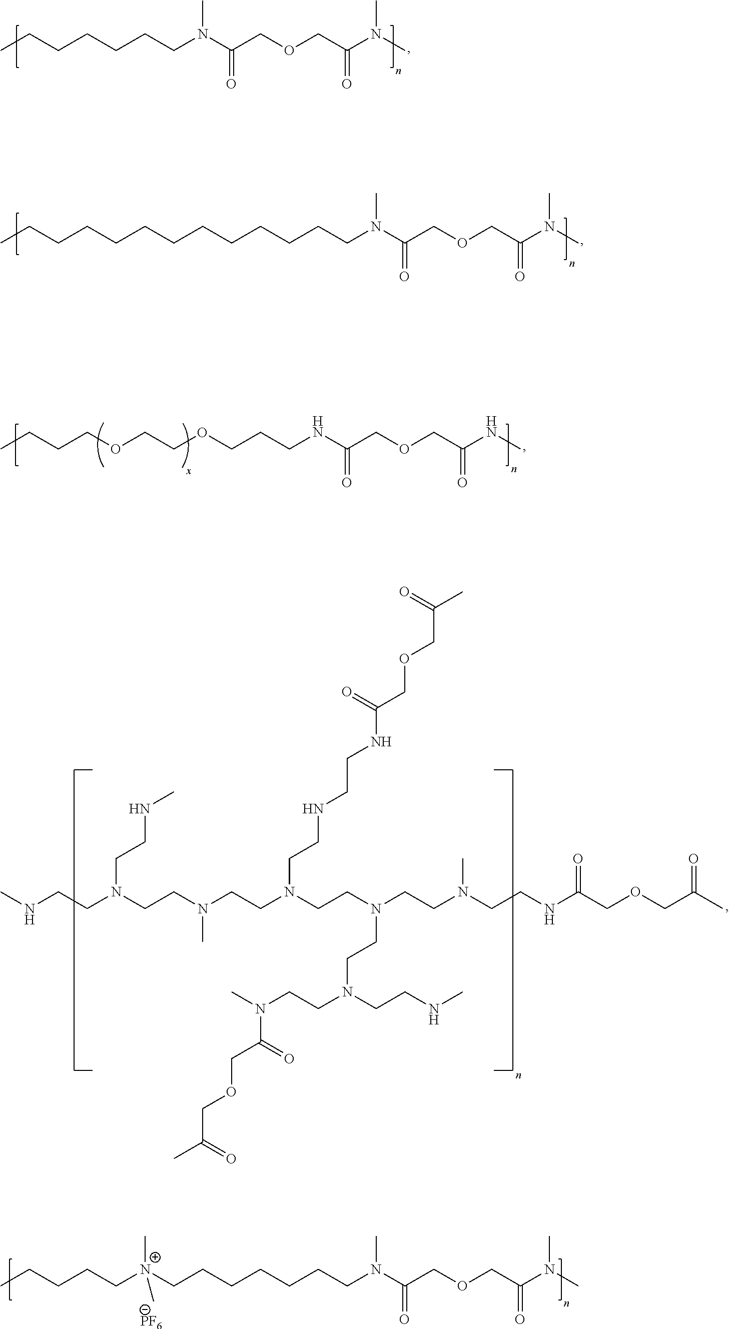 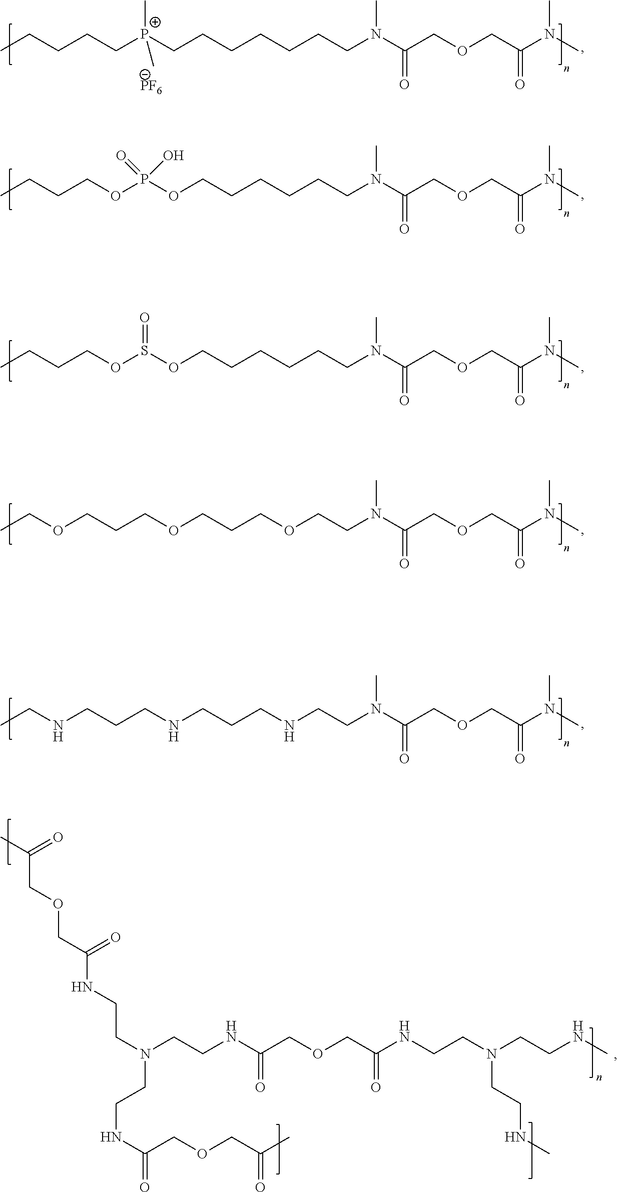 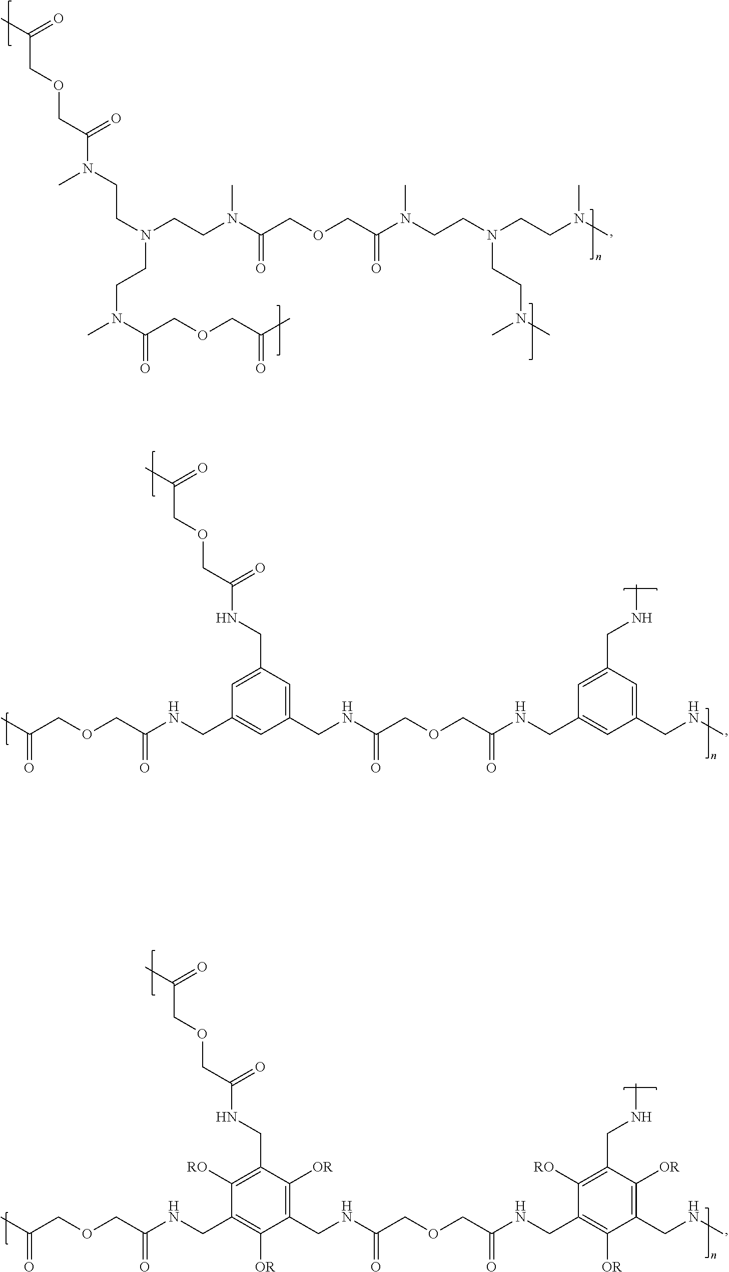 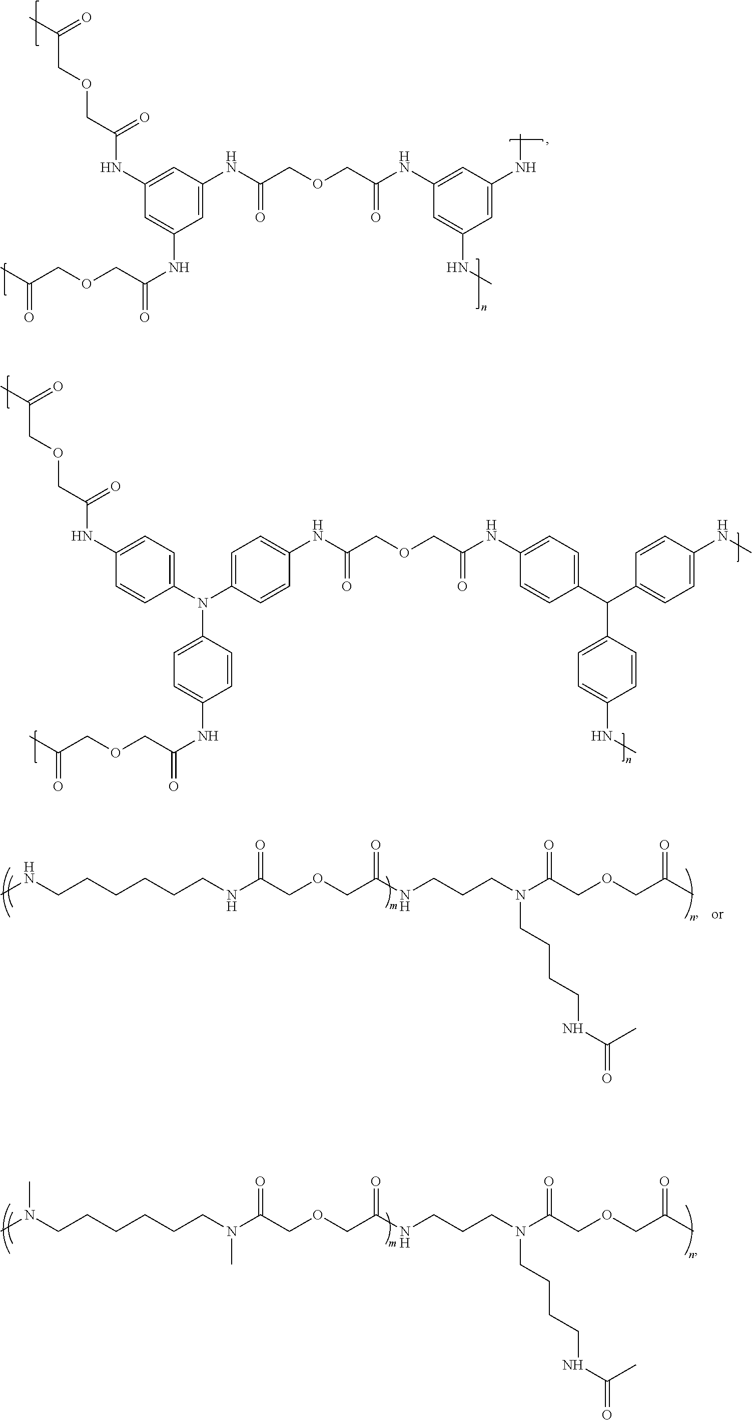
wherein R is a substituted or unsubstituted (C₁-C₃₀)hydrocarbyl optionally interrupted by 0, 1, 2, or 3 groups independently chosen from —O— and —S—, n is 2 to 1,000,000, m is 2 to 1,000,000, and x is 1 to 1,000,000.

9. The method of claim 1, wherein the polyamide is 0.001 wt % to 50 wt % of the heterogeneous solution and wherein the one or more metals have a concentration of 0.001 mM to 5 M in the aqueous solution.

10. The method of claim 1, wherein the one or more metals comprise Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof.

11. The method of claim 1, wherein the aqueous solution comprises one or more additional metals in addition to the one or more metals, the one or more additional metals comprising Li, Be, Na, Mg, Al, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, La, Ce, Pr, Nd, Sm, Eu, Gd, Tb, Dy, Ho, Er, Tm, Yb, Lu, Hf, Ta, W, Re, Os, Ir, Pt, Au, Hg, Tl, Pb, Bi, Po, Ra, Ac, Th, Pa, U, Np, Pu, Am Cm, Bk, Cf, Es, or a combination thereof, and wherein the one or more additional metals have a concentration of 0.001 mM to 5 M in the aqueous solution.

12. The method of claim 11, wherein the polyamide preferentially sorbs the one or more metals from the aqueous solution over the one or more additional metals, wherein a weight ratio of the one or more additional metals sorbed to the polyamide to the one or more metals sorbed to the polyamide is 0:1 to 0.9:1.

13. The method of claim 1, wherein the one or more metals comprise a rare earth metal, a precious metal, or a combination thereof.

14. The method of claim 1, wherein the polyamide sorbs 0.01 micromoles to 1 mole of the one or more metals per gram of the polyamide.

15. The method of claim 1, wherein the heterogeneous solution has a temperature of 0° C. to 100° C. and a pressure of 0.5 atm to 1.5 atm during the sorbing of the one or more metals to the polyamide.

16. The method of claim 1, wherein the aqueous solution and the heterogeneous solution are substantially free of organic solvents.

17. The method of claim 1, wherein removing the polyamide from the heterogeneous solution comprises decantation, filtration, centrifugation, sieving, or a combination thereof.

18. The method of claim 1, further comprising removing the one or more metals from the polyamide.

19. A method of forming the polyamide of claim 1, the method comprising:
combining one or more polyamines and a polyacid, polyacid ester, or polyacyl halide to form a reaction mixture comprising a polymeric ammonium salt; and
heating the polymeric ammonium salt to form the polyamide.

20. A method of extracting one or more metals from an aqueous solution, the method comprising:
forming a heterogeneous solution comprising a solid polyamide and the aqueous solution comprising the one or more metals therein, such that the polyamide sorbs at least some of the one or more metals in the aqueous solution, wherein the solid polyamide is substantially insoluble in the aqueous solution, and wherein the one or more metals comprise La, Ce, Pr, Nd, Sm, Eu, Gd, Tb, Dy, Ho, Er, Tm, Yb, Lu, Ca, Co, Mg, Mn, Ni, or a combination thereof; and
removing the polyamide from the heterogeneous solution to form a post-extracted solution having a lower concentration of the one or more metals than the aqueous solution;
wherein the polyamide is an amidization product of one or more polyamines and diglycolic acid.
